(19) United States
(12) Patent Application Publication
(10) Pub. No.: US 2025/0379967 A1
(43) Pub. Date: Dec. 11, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/301,917

(22) Filed: Aug. 15, 2025

Related U.S. Application Data
(63) Continuation of application No. PCT/CN2024/077152, filed on Feb. 9, 2024.

(30) Foreign Application Priority Data
Feb. 17, 2023 (WO) PCT/CN2023/076731
Feb. 28, 2023 (WO) PCT/CN2023/078828
Apr. 3, 2023 (WO) PCT/CN2023/086040
Apr. 10, 2023 (WO) PCT/CN2023/087416
Apr. 14, 2023 (WO) PCT/CN2023/088516
May 4, 2023 (WO) PCT/CN2023/092123
Oct. 11, 2023 (WO) PCT/CN2023/124118

(51) Int. Cl. H04N 19/105; H04N 19/167; H04N 19/186; H04N 19/196

(52) U.S. Cl. CPC H04N 19/105; H04N 19/167; H04N 19/186; H04N 19/196

(57) ABSTRACT

Embodiments of the present disclosure provide a solution for video processing. A method for video processing is proposed. The method comprises: performing a conversion between a current video block of a video and a bitstream of the video, wherein a first chroma component of the current video block is coded based on a first coding scheme, a second chroma component of the current video block is coded based on a second coding scheme, the second chroma component is different from the first chroma component and the second coding scheme is different from the first coding scheme.

### CROSS REFERENCE TO RELATED APPLICATIONS

This application is a continuation of International Application No. PCT/CN2024/077152, filed on Feb. 9, 2024, which claims the benefit of International Application No. PCT/CN2023/076731, filed on Feb. 17, 2023, International Application No. PCT/CN2023/078828, filed on Feb. 28, 2023, International Application No. PCT/CN2023/086040, filed on Apr. 3, 2023, International Application No. PCT/CN2023/087416, filed on Apr. 10, 2023, International Application No. PCT/CN2023/088516, filed on Apr. 14, 2023, International Application No. PCT/CN2023/092123, filed on May 4, 2023, International Application No. PCT/CN2023/124118, filed on Oct. 11, 2023. The entire contents of these applications are hereby incorporated by reference in their entireties.

### FIELDS

Embodiments of the present disclosure relates generally to video processing techniques, and more particularly, to coding scheme of different color components.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: performing a conversion between a current video block of a video and a bitstream of the video, wherein a first chroma component of the current video block is coded based on a first coding scheme, a second chroma component of the current video block is coded based on a second coding scheme, the second chroma component is different from the first chroma component and the second coding scheme is different from the first coding scheme.

According to the method in accordance with the first aspect of the present disclosure, the different chroma components of a same block are coded with different coding schemes. Compared with the conventional solution where the same coding scheme is used for coding different chroma components, the proposed method can advantageously support independent coding of different chroma components, and thus the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: perform a conversion between a current video block of the video and the bitstream, wherein a first chroma component of the current video block is coded based on a first coding scheme, a second chroma component of the current video block is coded based on a second coding scheme, the second chroma component is different from the first chroma component and the second coding scheme is different from the first coding scheme.

In a fifth aspect, a method for storing a bitstream of a video is proposed. The method comprises: perform a conversion between a current video block of the video and the bitstream, wherein a first chroma component of the current video block is coded based on a first coding scheme, a second chroma component of the current video block is coded based on a second coding scheme, the second chroma component is different from the first chroma component and the second coding scheme is different from the first coding scheme; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates the effect of the slope adjustment parameter;

FIG. 5 illustrates neighboring blocks used in the derivation of a general MPM list;

FIG. 6 illustrates neighboring reconstructed samples used for DIMD chroma mode;

FIG. 7 illustrates intra template matching search area used;

FIG. 8 illustrates the use of IntraTMP block vector for IBC block;

FIG. 9A illustrates a division method for angular modes;

FIG. 9B illustrates another division method for angular modes;

FIG. 10 illustrates extended MRL candidate list;

FIG. 11 illustrates an illustration of the template area;

FIG. 12 illustrates spatial part of the convolutional filter;

FIG. 13 illustrates reference area (with its paddings) used to derive the filter coefficients;

FIG. 14 illustrates four Sobel based gradient patterns for GLM;

FIG. 15 illustrates spatial GPM candidates;

FIG. 16 illustrates an GPM template;

FIG. 17 illustrates an GPM blending;

FIG. 18 illustrates possible positions of candidate regions;

FIG. 19 illustrates positions of the adjacent spatial candidates;

FIG. 20 illustrates various downsampling filters used in the proposed cross-component models;

FIG. 21 illustrates the positions of chroma samples;

FIG. 22 illustrates an example of luma samples to be prepared;

FIG. 23 illustrates an example of potential candidate regions;

FIG. 24 illustrates possible templates;

FIG. 25A illustrates possible above-left templates;

FIG. 25B illustrates possible left templates;

FIG. 25C illustrates possible above templates;

FIG. 26 illustrates an example of temporal candidates for intra prediction;

FIG. 27 illustrates a flowchart of a method for video processing in accordance with embodiments of the present disclosure; and

FIG. 28 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

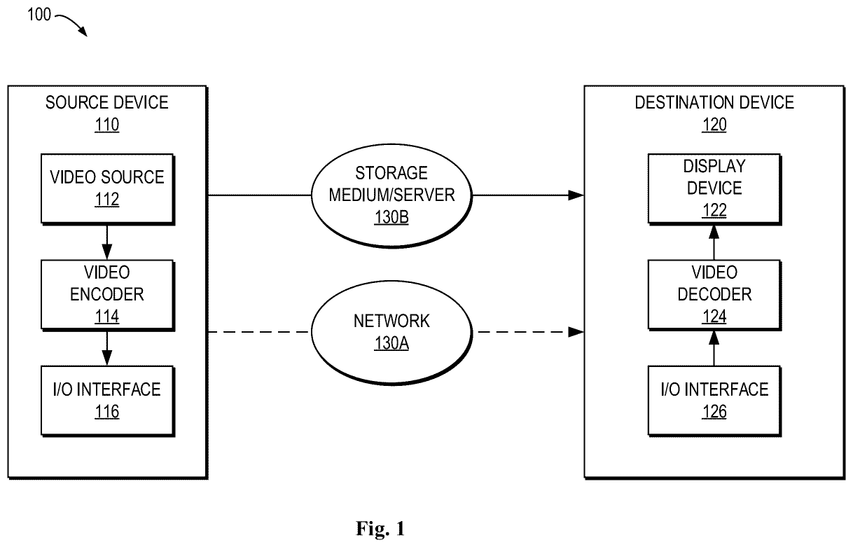

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

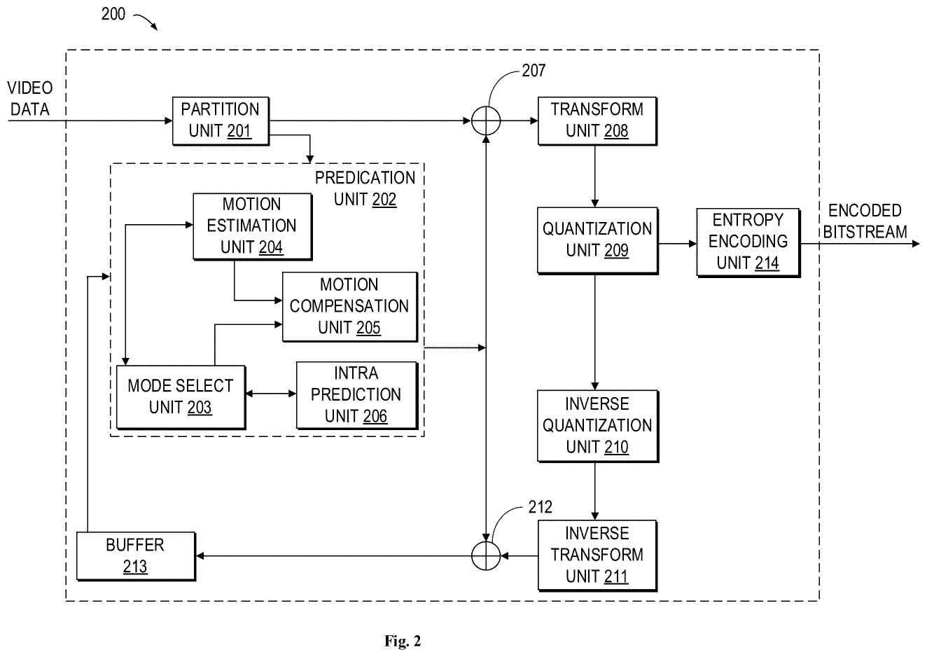

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

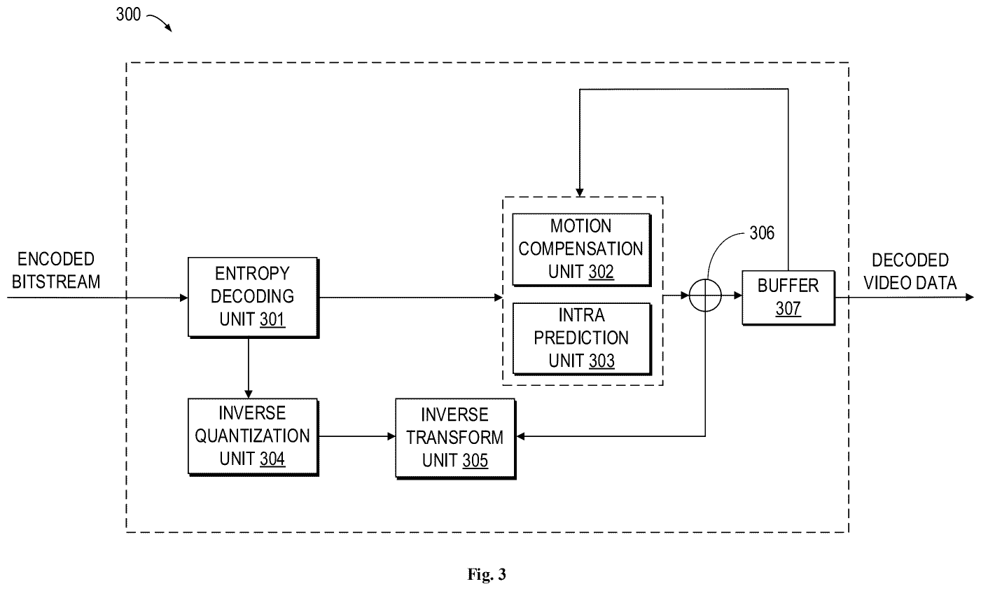

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about intra prediction in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

chroma Val=a*lumaVal+b.

An adjustment “u” to the slope parameter is signaled to update the model to the following form:

$$chromaVal = a ’ * lumaVal + b ’ \\ where \\ a ’ = a + u \\ b ’ = b - u * {y}_{r} .$$

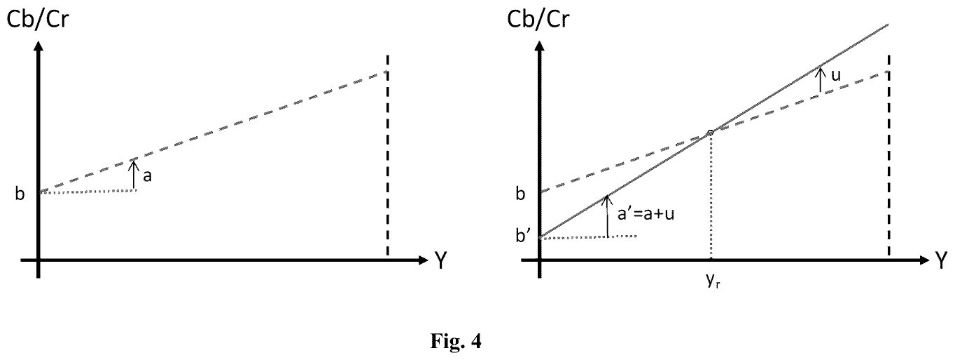

With this selection the mapping function is tilted or rotated around the point with luminance value yr. The average of the reference luma samples used in the model creation as yr in order to provide a meaningful modification to the model. FIG. 4 illustrates the process. More specifically, FIG. 4 illustrates of the effect of the slope adjustment parameter “u”. Left: model created with the current CCLM. Right: model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks, the directional modes with added offset from the first two available directional modes of neighbouring blocks, and the default modes.

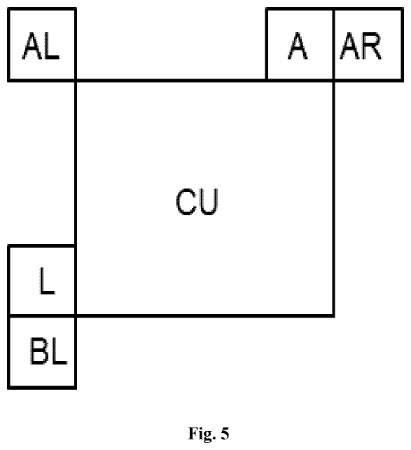

If a CU block is vertically oriented, the order of neighbouring blocks is A, L, BL, AR, AL; otherwise, it is L, A, BL, AR, AL. FIG. 5 illustrates neighbouring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation:

$$Orient = {G}_{y} / {G}_{x}$$

is computed by the following LUT-based scheme:

$$x = Floor ( Log 2 ( G x ) )$$

$$normDiff = ( ( Gx << 4 ) >> x ) \& 15$$

$$x += ( 3 + ( normDiff != 0 ) ? 1 : 0 )$$

$$Orient = ( Gy * ( DivSigTable [ normDiff ] \vert 8 ) + ( 1 << ( x - 1 ) ) ) >> x \\ where$$

$$DivSigTable = [ 16 ] \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

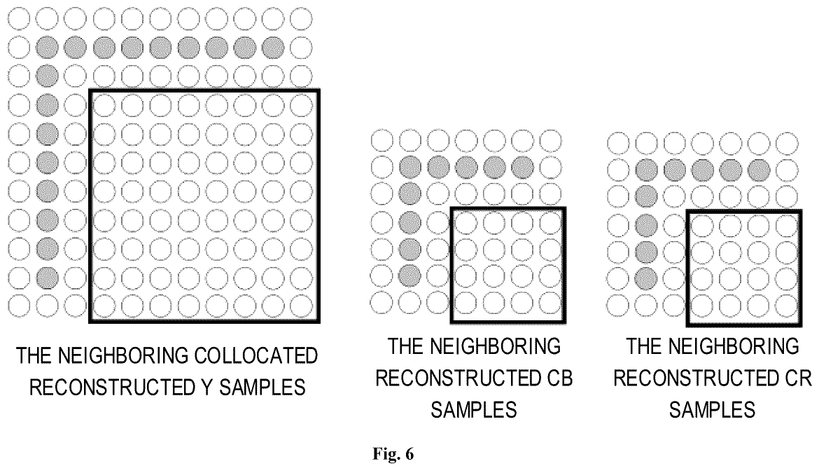

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block. FIG. 6 illustrates neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * p r e d 0 + w 1 * pred 1 + ( 1 << ( shift - 1 ) ) ) >> shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. This method only applies to I slices.

### 2.1.7 Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

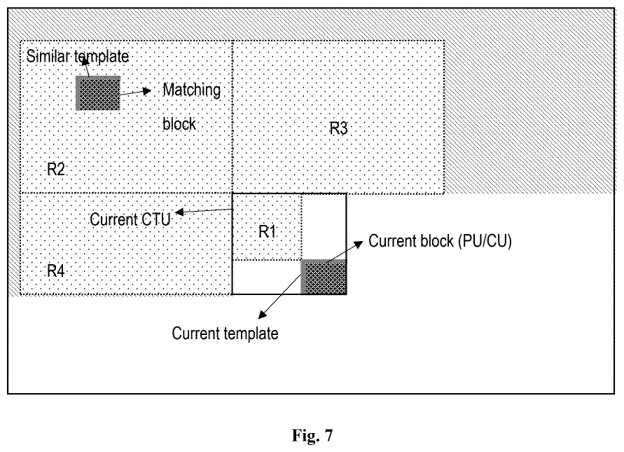

FIG. 7 illustrates intra template matching search area used. The prediction signal is generated by matching the L-shaped causal neighbor of the current block with another block in a predefined search area in FIG. 7 consisting of:
R1: current CTU.
R2: top-left CTU.
R3: above CTU.
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH ,\end{matrix}$$

where ‘a’ is a constant that controls the gain/complexity trade-off. In practice, ‘a’ is equal to 5.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min (BlkW, BlkH)/2.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

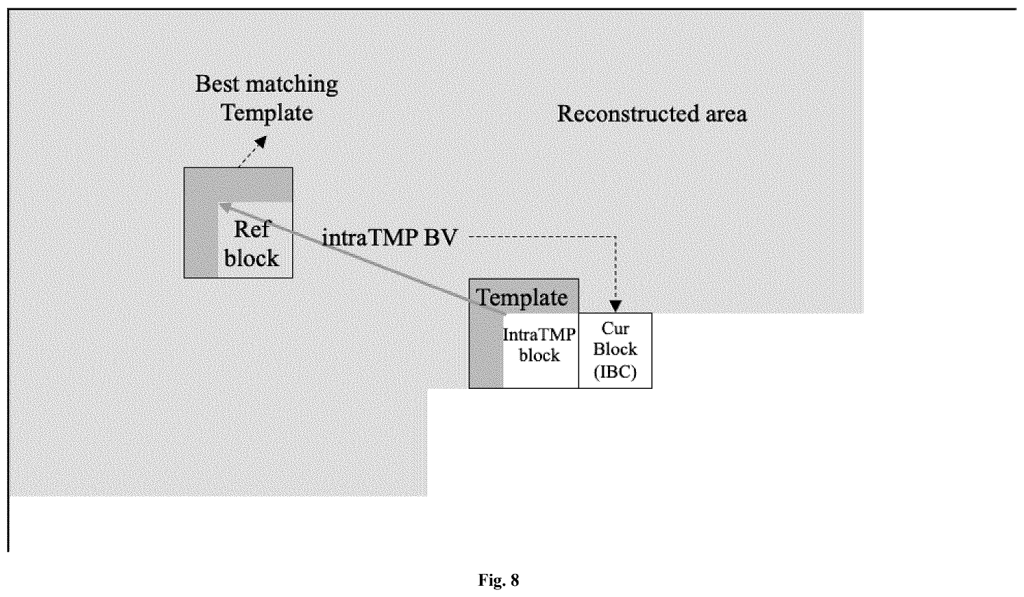

IntraTMP block vector is stored in the IBC block vector buffer and, the current IBC block can use both IBC BV and IntraTMP BV of neighbouring blocks as BV candidate for IBC BV candidate list as shown in FIG. 8. IntraTMP block vectors are added to IBC block vector candidate list as spatial candidates.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$\begin{matrix}weight 1 = costMode 2 / ( costMode 1 + costMode 2 ) , \\ weight 2 = 1 - weight 1.\end{matrix}$$

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as p_{fusion}=w₀ₚ_{ₗᵢₙₑ}+w₁ₚ_{ₗᵢₙₑ₊₁}, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the first mode (w₀=1, w₁=0) and pₗᵢₙₑ₊₁ is used for the second mode (w₀=0, w₁=1).
For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

2.1.10 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

In addition, it is also proposed to modify the weights (wIntra, wInter) for the two tests if the derived intra prediction mode is an angular mode. For near-horizontal modes (2<=angular mode index<34), the current block is vertically divided; for near-vertical modes (34<=angular mode index<=66), the current block is horizontally divided.

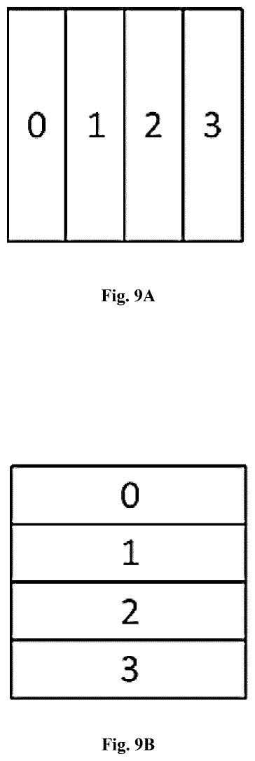

The (wIntra, wInter) for different sub-blocks are shown in FIGS. 9A and 9B. FIG. 9A illustrates a division method for angular modes, and FIG. 9B illustrates another division method for angular modes.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CHIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

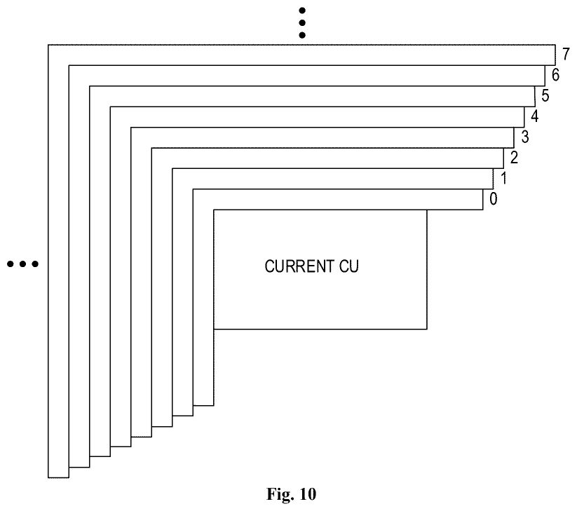

MRL list in VVC is extended to include more reference lines for intra prediction. The extended reference line list consists of line indices {1, 3, 5, 7, 12}. For template-based intra mode derivation (TIMD), instead of the full MRL candidate list, only the first two reference line candidates, i.e., {1, 3}, are used. FIG. 10 illustrates extended MRL candidate list.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode. The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs′ modes and DIMD modes if its not included and the angular modes with delta angles from ±1 to ±4 (compared the existing angular modes in the intra-prediction-mode candidate list) are added. The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list. For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma subsampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

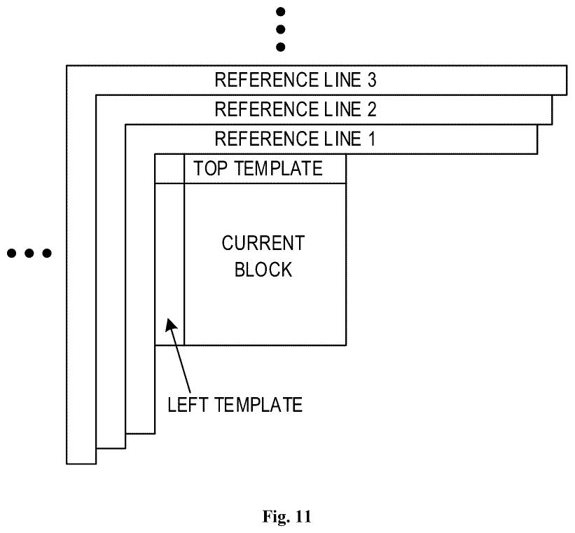

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 12.

The nonlinear term P is represented as power of two of the center luma sample C and scaled to the sample value range of the content:

$$P = ( C * C + midVal ) >> \text{bitdepth.}$$

That is, for 10-bit content it is calculated as:

$$P = ( C * C + 512 ) >> 10.$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.1.13.2 Calculation of Filter Coefficients

The filter coefficients cᵢ are calculated by minimising MSE between predicted and reconstructed chroma samples in the reference area. FIG. 13 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$$\begin{matrix}C ' = C - offsetLuma \\ N ' = N - offsetLuma \\ S ' = S - offsetLuma \\ E ' = E - offsetLuma \\ W ' = W - offsetLuma \\ P ' = nonLinear ( C ' ) \\ B = midValue = 1 << ( bitDepth - 1 )\end{matrix}$$

and the chroma value is predicted using the following equation, where offsetChroma is equal to offsetCr and offsetCb for Cr and Cb components, respectively:

$$predChromaVal = {c}_{0} C ' + {c}_{1} N ' + {c}_{2} S ' + {c}_{3} E ' + {c}_{4} W ' + {c}_{5} P ' + {c}_{6} B + offsetChroma .$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

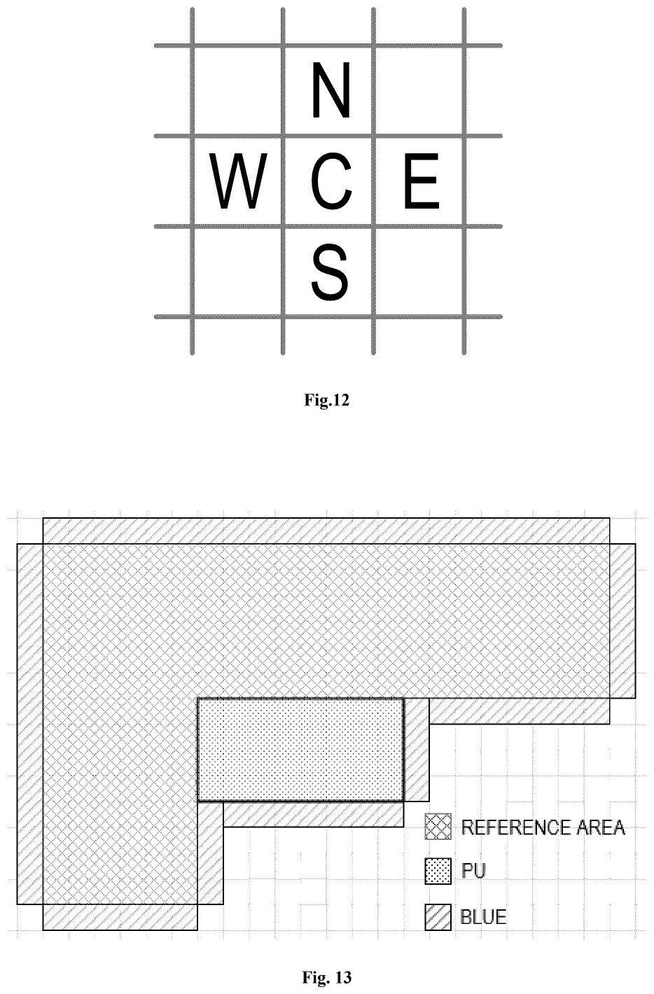

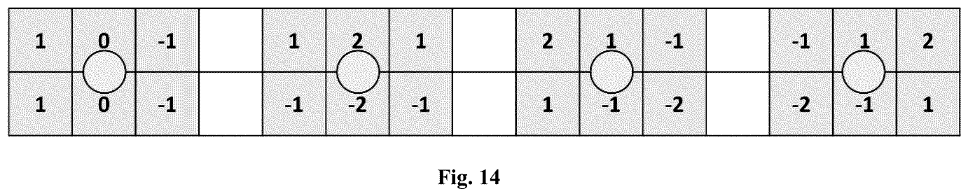

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14.

### 2.1.13.4 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.14 Spatial Geometric Partitioning Mode (SGPM)

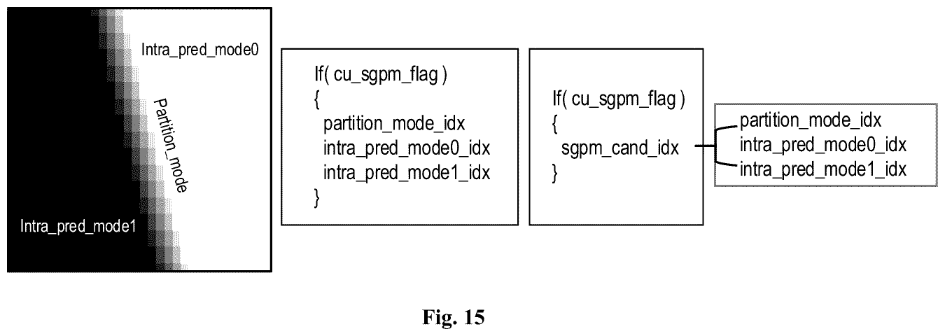

SGPM is an intra mode that resembles the inter coding tool of GPM, where the two prediction parts are generated from intra predicted process. In this mode, a candidate list is built with each entry containing one partition split and two intra prediction modes as shown in FIG. 15. 26 partition modes and 3 of intra prediction modes are used to form the combinations, the length of the candidate list is set equal to 16. The selected candidate index is signalled.

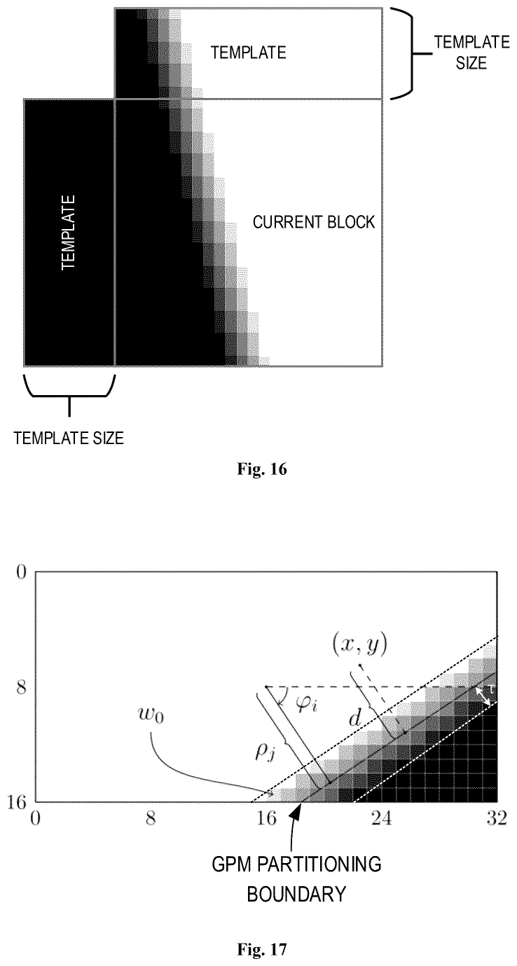

The list is reordered using template (FIG. 16) where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

Adaptive blending is also used for spatial GPM, where blending depth t shown in FIG. 17 is derived as follows:
If min (width, height)==4, ½ τ is selected,
else if min (width, height)==8, τ is selected,
else if min (width, height)==16, 2 τ is selected,
else if min (width, height)==32, 4 τ is selected,
else, 8 τ is selected.

### 2.1.15 Non-Local Cross-Component Prediction

Cross-component prediction (CCP) including CCLM, CCCM and their variants are adopted in ECM to exploit the cross-component correlation. With CCLM or CCCM, Training samples are always adjacent to the current block. However, the cross-component relationship of the current block may be more correlated to that of a non-local region.

Methods of non-local cross-component prediction are proposed to boost CCP by taking more advantage from non-local regions.

### Method #1:

Non-adjacent cross-component prediction (NA-CCP) mode is proposed. With NA-CCP mode, Samples in regions non-adjacent to the current block can be used to derive a CCCM model for the current block. A candidate region list with 6 candidates is constructed by checking potential 8×8 regions in order. If a checked region is available, it is put into the candidate region list. The top-left positions of the potential 8×8 regions are predetermined as {(−xStep, 0), (0, −yStep), (xStep, −yStep), (−xStep, yStep), (−xStep, −yStep), (−2*xStep, 0), (0, −2*yStep), (−2*xStep, 2*yStep), (2*xStep, −2*yStep), (−2*xStep, yStep), (xStep, −2*yStep), (−2*xStep, −yStep), (−xStep, −2*yStep), (−2*xStep, −2*yStep), (−xStep/2, 0), (0, −yStep/2), (xStep/2, −yStep/2), (−xStep/2, yStep/2), (−xStep/2, −yStep/2)}, where xStep=Max(width, 16), yStep=Max(height, 16). FIG. 18 shows some possible positions of candidate regions.

A flag is signaled to indicate whether NA-CCP is applied to a chroma block. If NA-CCP is applied, an index is signaled to indicate which candidate in the candidate region list is used to derive the CCCM model.

### Method #2:

History-based cross-component prediction (H-CCP) mode is proposed. With H-CCP, a H-CCLM table and a H-CCCM table are maintained similar to the HMVP table. After decoding a CCLM or CCCM coded block, the corresponding table is updated. In the implementation of H-CCP, the size of either H-CCLM table or H-CCCM table is 6. If the current block is coded with CCLM or CCCM mode, a flag is signaled to indicate whether H-CCP is applied. If H-CCP is used, an index is further signaled to indicate which candidate model in the H-CCLM table or H-CCCM table is selected.

### 2.1.16 Cross-Component Merge Mode for Chroma Intra Coding

Cross-component prediction (CCP) including cross-component linear model (CCLM), convolutional cross-component model (CCCM), and gradient linear model (GLM) are adopted in ECM to exploit the cross-component correlation. A cross-component merge (CCMerge) mode is proposed as a new CCP mode. Cross component model parameters of the current chroma block coded with CCMerge can be inherited from a neighboring block coded with CCP. Through CCMerge, CCP can be more efficient with less signalling overhead. In CCMerge, final cross-component model parameters of the current chroma block can be inherited from its spatial adjacent and non-adjacent neighbors, or default models. A list is created, which includes CCP models from the spatial adjacent and non-adjacent neighbors coded in CCLM, MMLM, CCCM, GLM, chroma fusion, and CCMerge modes. After including neighboring CCP models, default models are further included to fill the remaining empty positions in the list. To avoid including redundant CCP models in the list, pruning operations are applied. More details are described as follows.

### ⋅ Spatial Adjacent Neighboring Candidates

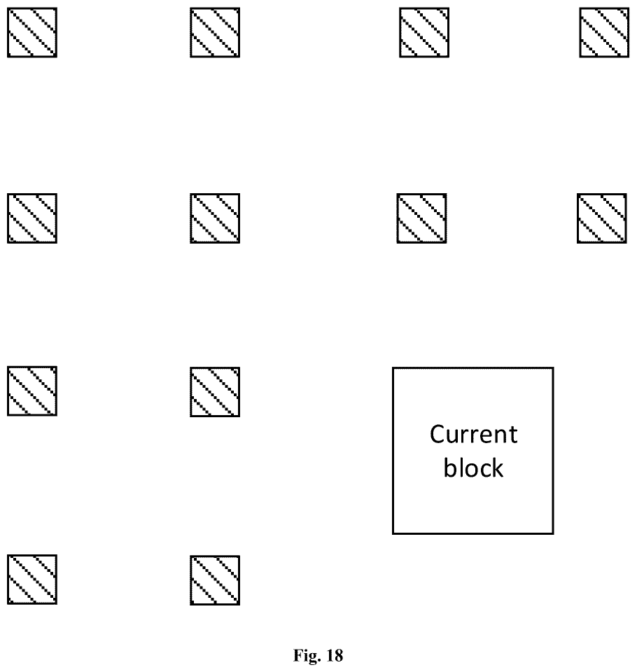

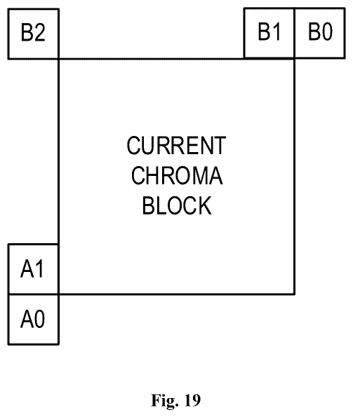

Positions of the spatial adjacent candidates are shown in FIG. 19. Spatial candidates are included in the following order: B1→A1→B0→A0→B2.

### ⋅ Spatial Non-Adjacent Neighboring Candidates

Spatial non-adjacent neighboring candidates are considered after all spatial adjacent neighbors are checked. In the current ECM design, in inter merge mode, two sets of spatial non-adjacent neighboring candidates are obtained. In the proposed method, positions and inclusion order of the spatial non-adjacent neighboring candidates from the first set are used.

⋅ CCLM Candidates with Default Scaling Parameters

CCLM candidates with default scaling parameters are considered after including the spatial adjacent and non-adjacent candidates if the list is not full. The default scaling parameters are {0, ⅛, −⅛, 2/8, − 2/8, ⅜}, and the offset parameter is derived according to the selected default scaling parameter, average neighboring reconstructed luma sample value (Yavg), and average neighboring reconstructed Cb/Cr sample value (Cavg).

### 2.1.16.1 Merging Model Candidates

When merging a CCLM candidate, only the scaling parameter is inherited. The offset parameter is derived by using the inherited scaling parameter, Yavg and Cavg.

When merging a MMLM candidate, the scaling parameters and the classification threshold are inherited. The offset parameter in each class is derived according to the inherited classification threshold and the Yavg and Cavg in each class. If no neighboring reconstructed samples are available in a class, the offset parameter is directly inherited from the candidate.

When merging a CCCM candidate, all convolution parameters, offsets (i.e., offsetLuma, offsetCb, and offsetCr), and the classification threshold are inherited.

When merging a GLM candidate, if the GLM candidate is 3-parameter GLM mode, all the gradient pattern index and model parameters are inherited; otherwise, if the GLM candidate is the 2-parameter GLM mode, the offset parameter is derived by using the inherited scaling parameter, Yavg, and Cavg.

When merging a chroma fusion candidate, the derived MMLM parameters are inherited and used as merging MMLM candidate.

For a CCMerge block, if its merging candidate mode is CCLM, MMLM, CCCM, or GLM, the merging candidate mode is stored as the propagation mode of the current chroma block; otherwise, if its merging candidate mode is chroma fusion, the propagation mode is set to MMLM. When merging a CCMerge candidate, how to inherit or derive the CCP parameters depends on the propagation mode of the CCMerge candidate, as described in the above five paragraphs.

### 2.1.16.2 Signaling

An additional flag is signalled indicating whether CCMerge is used or not after cclm_mode_flag syntax element. If CCMerge is used, a candidate index is additionally signalled. The signalled candidate index is shared for Cb/Cr color components. Currently, the maximum number of allowed candidates is set to 6 as default. If maximum number of allowed candidates is modified to 1, candidate index does not need to be signalled. Each bin of candidate index is context coded with a separate context.

### 2.1.17 CCCM Using Multiple Downsampling Filters (CCCM-MDF)

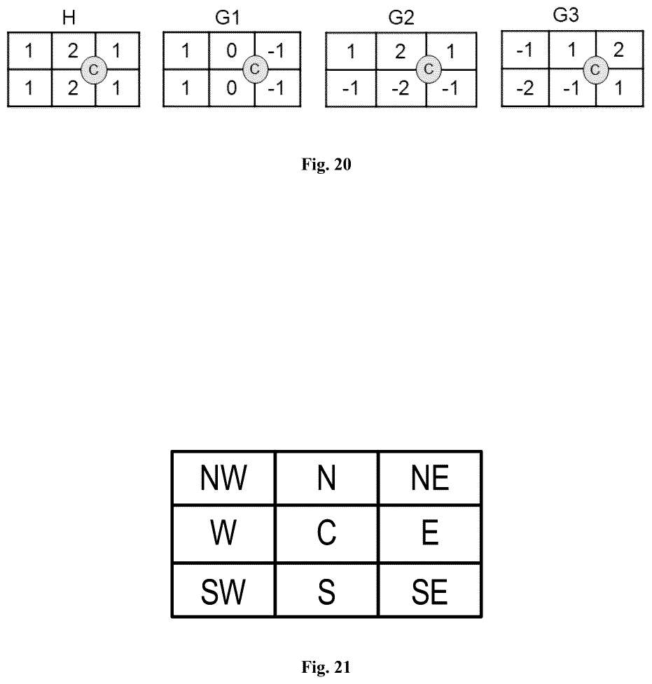

Multiple downsampling filters are applied to a group of reconstructed luma samples in a CCCM. The linear combination of these downsampled reconstructed samples is multiplied by derived filter coefficients to form the final chroma predictor. The horizontal or vertical location of the center luma sample may be also considered in the proposed model. The coefficients are derived by Gaussian elimination method as currently used by CCCM modes in ECM. The cross-component models shown below are tested as additional CCCM modes with a mode index signaled in the bitstream:

$$( 1 ) Model 1 : predChroma = c 0 * H ( C ) + c 1 * G 1 ( C ) + c 2 * G 2 ( C ) + c 3 * G 3 ( C ) + c 4 * P ( H ( C ) ) + c 5 * P ( G 1 ( C ) ) + c 6 * P ( G 2 ( C ) ) + c 7 * X + c 8 * Y + c 9 * B$$

$$( 2 ) Model 2 : predChroma = c 0 * H ( C ) + c 1 * H ( W ) + c 2 * H ( E ) + c 3 * G 1 ( C ) + c 4 * G 1 ( W ) + c 5 * G 1 ( E ) + c 6 * P ( H ( C ) ) + c 7 * P ( H ( W ) ) + c 8 * P ( H ( E ) ) + c 9 * X + c 10 * B$$

$$( 3 ) Model 3 : predChroma = c 0 * H ( C ) + c 1 * H ( NE ) + c 2 * H ( SW ) + c 3 * G 3 ( C ) + c 4 * G 3 ( NE ) + c 5 * G 3 ( S W ) + c 6 * P ( H ( C ) ) + c 7 * P ( H ( N E ) ) + c 8 * P ( H ( S W ) ) + c 9 * Y + c 10 * B$$

where H(⋅), G1(⋅), G2(⋅), G3(⋅) are various downsampling filters as indicated in FIG. 20, C denotes the current chroma sample position, and N, S, W, E, NE, SW are the positions around C as indicated in FIG. 21, cᵢ are filter coefficients, P and B are nonlinear term and bias term, and X and Y are the horizontal and vertical locations of the center luma sample with respect to the top-left coordinates of the block. It is noted that Model 1 is a 1×1 prediction shape using current chroma sample only while the other models are one-directional prediction models using 3 chroma samples.

### 2.1.18 History-Based Cross-Component Prediction (H-CCP)

1. It is proposed that the model(s) of cross-component prediction (CCP), such as CCLM or CCCM, in a block may be stored into a history table (HT).
   a. A HT is a list with ordered entries.
      i. Each entry has an index. For example, the index of the first entry is 0, and indices of following entries are 1, 2, 3, . . . .
   b. Model parameters of CCLM and its variants may comprise a, b and a shift which controls the calculation precision.
   c. Model parameters of CCLM and its variants may comprise linear parts such as c0˜c4 and nonlinear part such as c5.
   d. Models may include models for different color components such as Cb and Cr.
      i. For example, models for Cb and Cr may be coupled in a entry.
   e. In one example, different CCPs like CCLM and CCCM may share the same HT.
      i. In one example, a segment in an entry of the HT may reflect the type of CCP model(s) stored in the entry.
   f. In one example, different CCPs like CCLM and CCCM may have different HTs.
      i. In one example, one CCLM_HT may store models of CCLM and its variants like CCLM-L or CCLM-T.
      ii. In one example, one CCCM_HT may store models of CCCM and its variants like CCCM-T or CCCM-T.
   g. In one example, CCP with a single model (like CCLM or CCCM) and CCP with multiple models (like MM-CCLM or MM-CCCM) may have different HTs.
   h. In one example, CCP with a single model (like CCLM or CCCM) and CCP with multiple models (like MM-CCLM or MM-CCCM) may share the same HT.
      i. In one example, a segment in an entry of the HT may reflect the number of models stored in the entry.
      ii. In one example, a segment in an entry of the HT may reflect at least one threshold used to classify samples into different groups of models.
   i. In one example, a first HT is used to store models of CCLM and its variants.
      i. In one example, CCLM variants may comprise CCLM-L, CCLM-T, MM-CCLM, MM-CCLM-L, MM-CCLM-T, GLM and CCLM with slope adjustments.
         1) A segment in an entry of the HT may reflect the number of models stored in the entry.
         2) A segment in an entry of the HT may reflect at least one threshold used to classify samples into different groups of models.
         3) A segment in an entry of the HT may reflect whether GLM is applied.
         4) A segment in an entry of the HT may reflect the down-sampling filter of GLM.
   j. In one example, a second HT is used to store models of CCCM and its variants.
      i. In one example, CCCM variants may comprise CCCM-L, CCCM-T, MM-CCCM, MM-CCCM-L, MM-CCCM-T.
         1) A segment in an entry of the HT may reflect the number of models stored in the entry.
         2) A segment in an entry of the HT may reflect at least one threshold used to classify samples into different groups of models.
2. It is proposed that a block can be coded with history-based CCP (H-CCP) mode, in which mode at least one CCP model used by the current block is fetched or derived from a HT.
   a. In one example, at least one syntax element (SE) may be signaled to indicate whether H-CCP is applied.
      i. In one example, the SE may be signaled conditionally. E.g. the SE is signaled only if a specific mode is used, such as CCCM or CCLM.
         1) For example, the SE is signaled only if the current mode is CCCM or CCLM.
   b. In one example, at least one syntax element (SE) may be signaled to indicate which entry in a HT is fetched to derive the model(s) of cross-component prediction.
      i. The SE may reflect an index in the HT.
         1) In one example, the SE may be set equal to f(k) where k is an index and f is a function.
         2) In one example, the SE may be set equal to f(k, M) where k is an index, M is the number of valid entries in the HT and f is a function.
         a) In another example, M is the size of HT.
         3) In one example, the SE may be set equal to k where k is an index.
         4) In one example, the SE may be set equal to M−1−k where k is an index and M is the number of valid entries in the HT.
         a) In another example, M is the size of HT.
      ii. The SE may reflect an index of a list and the list may be constructed based on the HT.
         1) In one example, the list L is constructed by reversing the HT. For example, L[i]=HT[M−1−i], wherein M is the number of valid entries in the HT.
         a) In another example, M is the size of HT.
         b) In one example, L may have a fixed size.
         c) In one example, if L is not full, the vacant entries are filled with default entries.
      iii. In one example, the SE may be signaled conditionally. E.g. the SE is signaled only if H-CCP is applicable.
      iv. The SE may be signaled only if more than one entry in the HT can be selected.
      v. The maximum value (denoted as V) of the SE is determined by the number of entries to be selected.
         1) For example, V=K, or V=K−1, or V=K+1, or V=K−2, or V=K+2.
   c. In one example, at least one syntax element (SE) may be signaled to indicate which HT is used.
      i. In one example, the SE may be signaled conditionally. E.g. the SE is signaled only if H-CCP is applicable.
      ii. The SE may be signaled only if more than one HTs can be selected.
   d. In one example, it may be derived at encoder/decoder which HT is used.
      i. In one example, if the current mode is CCLM, a first HT storing models of CCLM and its variants is used.
      ii. In one example, if the current mode is CCCM, a second HT storing models of CCCM and its variants is used.
   e. In one example, the current block may be predicted with the CCP model fetched from the determined entry of the determined HT.
   f. In one example, the current block may be predicted with either CCCM or CCLM based on whether the first HT or the second HT is applied.
   g. In one example, the current block may be predicted with multiple models.
      i. Whether single model or multiple models are applied may be derived/fetched from the determined entry of the determined HT.
      ii. At least one threshold used to classify samples into different groups of models may be fetched/derived from the determined entry of the determined HT.

### Maintenance of the HT

3. The maximum size of a HT may be predetermined, such as to be 5 or 6.
   a. Alternatively, the maximum size of a HT may be signaled as a SE at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
   b. Alternatively, the maximum size of a HT may be derived using coding/decoding information such as:
      i. The mode of the current block;
      ii. The mode of a neighbouring block;
      iii. The mode of a luma block in the collocated region of the current block;
      iv. The mode of a luma block in the collocated region of a neighbouring block;
      v. QP;
      vi. Slice/picture type;
      vii. Picture width/height;
      viii. Block width/height;
      ix. Reconstructed samples.
4. A HT may be refreshed at the beginning of encoding/decoding a sequence/picture/slice/tile/sub-picture/CTU row/CTU.
   a. For example, a HT may be refreshed by emptying the table.
   b. For example, a HT may be refreshed by fulfilling the table with default entries.
5. After encoding/decoding a block (such as a CU), a HT may be updated.
   a. For example, the CU must be a chroma CU when dual-tree coding is applied.
   b. For example, the CU must be a CU with CCP modes.
   c. For example, which HT to be updated may depend on the coding mode of the CU.
      i. For example, if the CU is coded with a CCLM mode (such as CCLM, CCLM-L, CCLM-T, MM-CCLM, MM-CCLM-L, MM-CCLM-T, GLM and CCLM with slope adjustments), the model(s) and related information (such as threshold(s) used to classify samples into different groups of models) are stored in the first HT.
      ii. For example, if the CU is coded with a CCCM mode (such as CCCM, CCCM-L, CCCM-T, MM-CCCM, MM-CCCM-L, MM-CCCM-T), the model(s) and related information (such as threshold(s) used to classify samples into different groups of models) are stored in the first HT.
   d. For example, a set of information related to the CCP model(s) used by the current block may be put into the HT.
      i. The set may comprise one or multiple CCP models.
      ii. The set may comprise the number of models.
      iii. The set may comprise threshold(s) used to classify samples into different groups of models).
      iv. The set may comprise slope adjustments.
   e. In one example, the CCP model may be adjusted before being used to update the HT, if the current block is coded with CCLM with slope adjustments.
6. How to put a new set of information related to the CCP model(s) into a HT may depend on whether the HT is full.
   a. For example, if the HT is not full, the new set may be put to the first vacant entry of the HT.
      i. For example, the first vacant entry is the vacant entry with the smallest index.
      ii. For example, the first vacant entry is the vacant entry with the largest index.
      iii. After being put into the HT, the new set may be put as the last occupied entry in the HT.
         1) The last occupied entry may be the occupied entry with the largest index.
         2) The last occupied entry may be the occupied entry with the smallest index.
   b. For example, if the HT is full, one existing entry in the HT may be removed.
      i. In one example, the HT may be managed in a First In First Out way.
      ii. The existing entry with the smallest index may be removed.
         1) The updated HT′ may be set as: HT′[i]=HT[i+1], for 0<=i<=N−2, and HT′[N−1]=new set, wherein N is the size of HT.
      iii. The existing entry with the largest index may be removed.
         1) The updated HT′ may be set as: HT′[i]=HT[i−1], for 1<=i<=N−1, and HT′[0]=new set, wherein N is the size of HT.
7. In one example, the new set may be compared with at least one of the existing entries in the HT to determine whether to put into the new set and/or how to update the HT.
8. In one example, if the new set is the same or similar to one of the existing entries in the HT, the new set is not put into the HT. Suppose the new set is the same or similar to a special entry of HT.
   a. For example, in such a case, the special entry may be put to the first of the HT, and the entries originally before the special entry are pushed one position backward.
      i. For example, suppose entries are HT[i] with i=0, 1 . . . , and the special entry is HT[k], then the updated HT′ will be as: HT′[0]=HT[k]; HT′[i]=HT[i−1] for 1<=i<=k; HT′[i]=HT[i] for i>k.
   b. For example, in such a case, the special entry may be put to the end of the HT, and the entries originally before the special entry are pushed one position forward.
      i. For example, suppose entries are HT[i] with i=0, 1 . . . , and the special entry is HT[k], then the updated HT′ will be as: HT′[N−1]=HT[k]; HT′[i]=HT[i+1] for k<=i<=N−2; HT′[i]=HT[i] for i<k.
9. In one example, whether to put into the new set and/or how to update the HT may depend on the coding information of the CU with the new set.
10. In one example, if the new set is of a CU coded with H-CCP mode, the new set is not put into the HT. Suppose a special entry in HT is used by the CU coded with H-CCP.
   a. For example, in such a case, the special entry may be put to the first of the HT, and the entries originally before the special entry are pushed one position backward.
      i. For example, suppose entries are HT[i] with i=0, 1 . . . , and the special entry is HT[k], then the updated HT′ will be as: HT′[0]=HT[k]; HT′[i]=HT[i−1] for 1<=i<=k; HT′[i]=HT[i] for i>k.
   b. For example, in such a case, the special entry may be put to the end of the HT, and the entries originally before the special entry are pushed one position forward.
      i. For example, suppose entries are HT[i] with i=0, 1 . . . , and the special entry is HT[k], then the updated HT′ will be as: HT′[N−1]=HT[k]; HT′[i]=HT[i+1] for k<=i<=N−2; HT′[i]=HT[i] for i<k.
11. It is proposed that an entry of HT may include models for more than one chroma components, such as Cb and Cr.
   a. If an entry is selected, then the models for component Cb and Cr are applied on the two components respectively.
12. It is proposed that an entry of HT may include models for only one component, such as Cb or Cr.
   a. If an entry is selected, then the model for the specific component such as Cb or Cr is applied on the specific component.
   b. In one example, different HT may be built for different components.

### List Mode

13. It is proposed that at least one list with CCP models may be constructed.
   a. In one example, a chroma block may be predicted with a CCP model in the list, with a “list mode”.
   b. In one example, the list L may be filled with one type of CCP models, such as CCCM.
   c. In one example, the list may be filled with multiple types of CCP models, such as both CCCM and CCLM.
      i. In one example, the type of the CCP model will be stored in the list together with the CCP model.
   d. In one example, at least one syntax element (SE) may be signaled to indicate whether a CCP model in the list is used.
      i. In one example, the SE may be signaled conditionally. E.g. the SE is signaled only if a specific mode is used, such as CCCM or CCLM.
         1) For example, the SE is signaled only if the current mode is CCCM or CCLM.
         2) For example, the SE is signaled only if the “list mode” is applicable.
   e. In one example, at least one syntax element (SE) may be signaled to indicate which entry in the list is used to derive the model(s) of cross-component prediction.
      i. The SE may reflect an index in the list.
         1) In one example, the SE may be set equal to f(k) where k is an index and f is a function.
         2) In one example, the SE may be set equal to f(k, M) where k is an index, M is the number of valid entries in the list and f is a function.
         a) In another example, M is the size of list.
         3) In one example, the SE may be set equal to k where k is an index.
         4) In one example, the SE may be set equal to M−1−k where k is an index and M is the number of valid entries in the list.
         a) In another example, M is the size of list.
   f. In one example, L may have a fixed size.
   g. In one example, multiple lists may be constructed.
      i. For example, at least one syntax element (SE) may be signaled to indicate which list is used.
      ii. In one example, the SE may be signaled conditionally. E.g. the SE is signaled only if “list mode” is applicable.
      iii. The SE may be signaled only if more than one list can be selected.
   h. In one example, it may be derived at encoder/decoder which list is used.
      i. In one example, if the current mode is CCLM, a first list storing models of CCLM and its variants is used.
      ii. In one example, if the current mode is CCCM, a second list storing models of CCCM and its variants is used.
14. It is proposed that an entry of list may include models for more than one chroma components, such as Cb and Cr.
   a. If an entry is selected, then the models for component Cb and Cr are applied on the two components respectively.
15. It is proposed that an entry of list may include models for only one component, such as Cb or Cr.
   a. If an entry is selected, then the model for the specific component such as Cb or Cr is applied on the specific component.
16. Multiple candidates may be put into the list, including.
   a. A CCP model of an adjacent neighbouring block.
   b. A CCP model of a non-adjacent neighbouring block.
   c. A CCP model of a collocated block in a reference picture.
   d. A CCP model of a reference block in a reference picture.
   e. A CCP model in a history table.
   f. A CCP model derived from non-adjacent samples.
   g. A default CCP mode.
17. In one example, a list may be constructed by checking possible candidates in an order.
   a. For example, the order may be adjacent neighbouring blocks, non-adjacent neighbouring blocks, models in a history table, models derived from non-adjacent samples.
   b. For example, the list construction is finished if the number of candidates in the list achieves the maximum allowed size of the list (such as 5 or 6).
   c. For example, the list construction is finished if the number of candidates in the list achieves f(d), where d is the index of the selected candidate and f is a function. For example, f(d)=d+1.
   d. For example, default models may be put into the list if all possible candidates have been checked the the construction is not finished.
18. In one example, if a potential candidate is put into the list, it may be compared with at least one existing candidate in the list.
   a. For example, the potential candidate is not put into the list, if it is the same or similar to the existing candidate.
   b. In one example, if a potential entry of CCP information is put into the history-based table, it may be compared with at least one existing entries in the list.
      i. For example, the potential entry is not put into the list, if it is the same or similar to an existing entry.
   c. In one example, two CCP candidates or entries are determined NOT to be the same if:
      i. The CCP types are different.
      ii. The numbers of models are different.
      iii. The thresholds are different if the CCP has multiple models.
      iv. At least one model is different.
      v. The luma sample offset is different. (maybe only applicable if the type is CCCM or GL-CCCM or GLM or CCCM with using non-downsampled luma samples.).
      vi. The sample location shifts are different. (maybe only applicable if the type is GL-CCCM).
19. For example, CCP information of an entry in the history-based table or of a candidate in a CCP candidate list may comprise:
   a. The type of the CCP method, such as CCLM or CCCM or GLM or GLM with luma or GL-CCCM or CCCM using non-downsampled luma samples.
      i. In one example, GLM method using different down-sampling filters may be considered as different types.
      ii. In one example, GLM with luma method using different down-sampling filters may be considered as different types.
      iii. In one example, the types may be CCCM, CCLM, 4 types of GLM using different down-sampling filters, 4 types of GLM with luma using different down-sampling filters, GL-CCCM and CCCM using non-downsampled luma samples.
      iv. “Not coded with CCP” (denoted as NonCCP) may also be treated as a type.
   b. The position (x, y).
   c. The number of models.
      i. For example, the number of models may be 1 or 2.
      ii. In one example, the number of models may be considered as a part of the CCP type. For example, CCLM and MM-CCLM may be considered as two types.
   d. At least one threshold to classify samples for different models.
      i. The threshold may be used only if the number of models is at least 2.
   e. At least one luma sample value offset.
      i. The luma sample value offset may be added to or subtracted from a luma sample (which may be down sampled) when it is used to derive a chroma prediction value.
      ii. The luma sample value offset may be used only for specific types such as CCCM, GLM with luma, GL-CCCM and CCCM using non-down-sample luma samples.
   f. At least one chroma sample value offset.
      i. The chroma sample value offset may be added to or subtracted from a chroma prediction value derived by a CCP model to generate the final prediction.
   g. At least one models for at least one chroma component.
      i. For example, it may include different models for Cb and Cr components.
      ii. For example, the number of models for each component may be included as a part of the information.
      iii. The model may be represented by the model form of CCLM or CCCM or GLM or GLM with luma or GL-CCCM or CCCM using non-downsampled luma samples.
   h. At least one sample location shift denoted as (dX, dY).
      i. The chroma sample location shift may be added to or subtracted from the sample location (x, y) when it is used to derive the chroma prediction value.
      ii. The chroma sample location shift may be used only for specific types such as GL-CCCM.
20. For example, the CCP coding information of a chroma block after being coded/decoded may be stored in the history-based table or in the CCP candidate list.
   a. In one example, the CCP coding information may be stored only if the chroma block is coded with a CCP mode.
      i. In one example, the CCP coding information may be stored if the chroma block is coded with at least one CCP mode, such as with the fusion of chroma intra prediction mode.
         1) The stored type may be set to bethe CCP type used in the fusion of chroma intra prediction mode.
   b. In one example, the CCP coding information may be stored for any chroma block.
      i. If the chroma block is not coded with a CCP mode, the type is stored as “NonCCP”.
   c. If the chroma block is coded with a CCP mode, the type of information may be stored as depending on the coding mode.
      i. The type is set to be “CCCM” if the mode is CCCM, or CCCM-T, or CCCM-L, or MM-CCCM, or MM-CCCM-T, or MM-CCCM-L.
      ii. The type is set to be “CCLM” if the mode is CCLM, or CCLM-T, or CCLM-L, or MM-CCLM, or MM-CCLM-T, or MM-CCLM-L.
      iii. The type is set to be “CCLM” if the mode is CCLM, or CCLM-T, or CCLM-L, or MM-CCLM, or MM-CCLM-T, or MM-CCLM-L, with slope adjustments.
      iv. The type is set to be “GLM using filter X” if the mode is GLM using filter X.
      v. The type is set to be “GLM with luma using filter X” if the mode is GLM with luma using filter X.
      vi. The type is set to be “GL-CCCM” if the mode is GL-CCCM.
      vii. The type is set to be “CCCM using non-down-sample” if the mode is CCCM using non-down-sample.
      viii. The type is set to be “CCLM” if the mode is the fusion of chroma intra prediction mode.
   d. The number of models may be stored as the number of models of the chroma block.
      i. For example, the number of models is set to be 2 if the mode is MM-CCLM, or MM-CCLM-T, or MM-CCLM-L, or MM-CCLM, or MM-CCLM-T, or MM-CCLM-L or any other multi-model CCP modes (such as GLM or GL-CCCM or CCCM using non-downsampled luma samples with multi-models).
   e. Information such as the threshold, the luma/chroma sample value offset, sample location shift may be stored as the information used by the chroma block.
   f. The CCP model of one component may be stored as the model used by the chroma block.
      i. The model may be derived by any CCP method such as CCLM, or CCLM-T, or CCLM-L, or MM-CCLM, or MM-CCLM-T, or MM-CCLM-L or CCCM, or CCCM-T, or CCCM-L, or MM-CCCM, or MM-CCCM-T, or MM-CCCM-L or GLM using different down-sampling filters, or GLM with luma using different down-sampling filters, or GL-CCCM or CCCM using non-downsampled luma samples.
      ii. The stored model may be the final applied one, such as the one after been modified by the slope adjustment.
21. In one example, a history table of CCP information after coding/decoding a region (such as a CU/CTU/CTU line) may be stored, known as a stored table.
   a. The history table of CCP information maintained for the current block (known as an online table) may be used together with the stored history table of CCP information.
   b. In one example, entries in a stored table and in an on-line table may be checked in an order to generate new candidates.
      i. In one example, entries in the on-line table may be checked before all entries in the stored table.
      ii. In one example, entries in the stored table may be checked before all entries in the on-line table.
      iii. For example, k-th entry in the stored table may be checked after the k-th entry in the on-line table.
      iv. For example, k-th entry in the on-line table may be checked after the k-th entry in the stored table.
      v. For example, k-th entry in the on-line table may be checked after all the m-th entries, in the stored table, for m=0 . . . . S where S is an integer.
      vi. For example, k-th entry in the stored table may be checked after all the m-th entries, in the on-line table, for m=0 . . . . S where S is an integer.
      vii. For example, k-th entry in the on-line table may be checked after all the m-th entries, in the stored table, for m=S . . . maxT, where S is an integer and maxT is the last entry.
      viii. For example, k-th entry in the stored table may be checked after all the m-th entries, in the on-line table, for m=S . . . maxT, where S is an integer and maxT is the last entry.
   c. In one example, which stored table(s) to be used may depend on the dimension and/or location of the current block.
      i. For example, the table stored in the CTU above the current CTU may be used.
      ii. For example, the table stored in the CTU left-above to the current CTU may be used.
      iii. For example, the table stored in the CTU right-above to the current CTU may be used.
   d. In one example, whether to and/or how to use a stored table may depend on the dimension and/or location of the current block.
      i. In one example, whether to and/or how to use a stored table may depend on whether the current CU is at the top boundary of a CTU and the above neighbouring CTU is available.
         1) For example, a stored table may be used only if the current CU is at the top boundary of a CTU and the above neighbouring CTU is available.
         2) For example, at least one entry in a stored table may be put to a more forward position if the current CU is at the top boundary of a CTU and the above neighbouring CTU is available.
   e. In one example, entries in two stored tables may be checked in an order to generate new candidates.
      i. For example, a first (or a second) stored table may be stored in the CTU above the current CTU may be used.
      ii. For example, a first (or a second) stored table may be stored in the CTU left-above to the current CTU may be used.
      iii. For example, a first (or a second) stored table may be stored in the CTU right-above to the current CTU may be used.

### 2.1.19 Non-Adjacent Cross-Component Prediction (NA-CCP)

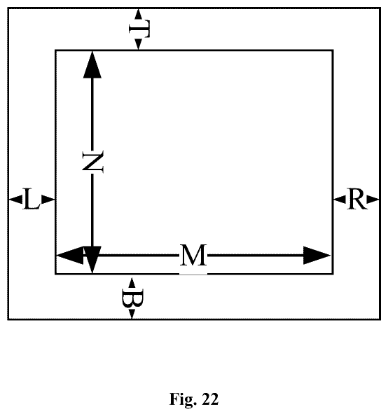

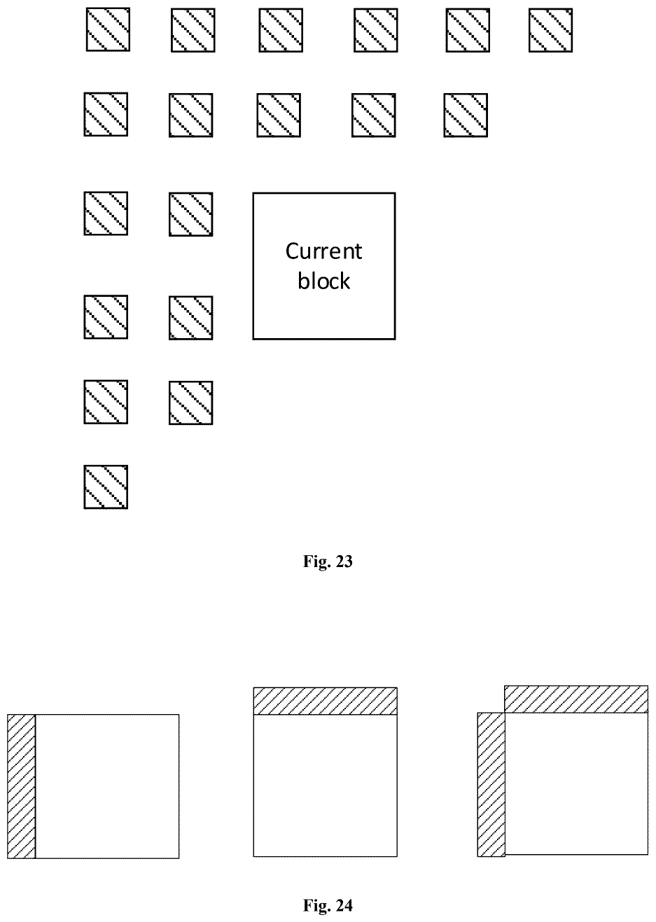

1. It is proposed that the model(s) of cross-component prediction, such as CCLM or CCCM, in a block may be derived based on a set of samples non-adjacent to the current block, known as non-adjacent cross-component prediction (NA-CCP).
   a. In one example, the set of samples are non-adjacent to the current block only if no sample in the set is adjacently neighbouring to the current block (such as adjacent above or adjacent left to the current block).
   b. In one example, the set of samples are reconstructed before coding/decoding the current block.
   c. The samples may comprise chroma samples and/or their corresponding luma samples, which may be generated by down-sampling if the color format is 4:2:0 or 4:2:2.
2. In one example, at least one syntax element (SE) may be signaled to indicate whether non-adjacent cross-component prediction is applied.
   a. In one example, the SE may be signaled conditionally. e.g. the SE is signaled only if a specific mode is used, such as CCCM or CCLM.
3. In one example, more than one sets of samples non-adjacent to the current block may be used to derive the model(s) of cross-component prediction.
   a. In one example, samples in more than one sets may be jointly used to derive the model(s) of cross-component prediction.
   b. In one example, one set of multiple candidate sets may be selected to derive the model(s) of cross-component prediction.
4. In one example, at least one syntax element (SE) may be signaled to indicate which set of non-adjacent samples is used to derive the model(s) of cross-component prediction.
   a. In one example, the SE may be signaled conditionally. E.g. the SE is signaled only if NA-CCP is applicable.
   b. The SE may be signaled only if more than one sets of non-adjacent samples can be selected.
   c. The maximum value (denoted as V) of the SE is determined by the number of sets of non-adjacent samples (denoted as K) to be selected.
      i. For example, V=K, or V=K−1, or V=K+1, or V=K−2, or V=K+2.
5. Whether to/how to apply NA-CCP may be the same for more than one color components, such as Cb and Cr.
   a. Alternatively, whether to/how to apply NA-CCP may be different for different components, such as Cb and Cr.
6. Whether NA-CCP is applicable may depend on the dimension/position of the current block.
7. In one example, a set of non-adjacent samples may comprise samples in a region.
   a. In one example, the region may be a coding block (e.g. a CU).
   b. In one example, the region may be represented by a position relative to the region.
   c. In one example, the region may be a M×N rectangle (e.g. M=N=8).
   d. In one example, the rectangular region may be represented by a position relative to the region (such as the top-left position (x, y) of the region) and dimensions M×N.
   e. In one example, the regions of different sets of non-adjacent samples may share the same shape and size.
   f. In one example, the regions of different sets of non-adjacent samples may have different shapes or sizes.
   g. A sample in the region must be reconstructed.
      i. Alternatively, if a sample in the region is not reconstructed, it should be padded.
8. In one example, luma samples corresponding to a set of non-adjacent chroma samples may be prepared or generated, to be used to train the cross-component model.
   a. In one example, down-sampling may be applied to generate the corresponding luma samples if the color format is 4:2:0 or 4:2:2.
   b. In one example, generated luma samples may correspond to a region larger than the region of non-adjacent chroma samples.
      i. In one example, suppose the region of non-adjacent chroma samples is a M×N rectangle, then the generated luma samples may correspond to a (M+T+B)×(N+L+R) chroma rectangle, as shown in FIG. 22.
         1) In one example, T=B=L=R=1.
   c. In one example, if a luma sample to be generated is not available (e.g., it is out of the picture boundary, or it is not reconstructed, or it is in a different CTU which has not been reconstructed, etc.), it may be specially treated.
      i. In one example, it may be padded, such as repetition padded with the nearby available generated luma value.
      ii. In one example, it may not be generated not marked as “unavailable”.
         1) The dimensions of the luma region may be set to be the available region.
9. In one example, whether a region comprising the non-adjacent samples is a valid set of samples to derive model(s) may be determined by the availability of at least one sample of the region.
   a. For example, the region is a rectangle.
   b. For example, the region is determined to be valid only if the top-left reconstructed sample and bottom-right reconstructed sample of the region are both available.
   c. For example, the region is determined to be valid only if the top-right reconstructed sample and bottom-left reconstructed sample of the region are both available.
10. In one example, a region list may be constructed to record the multiple sets of non-adjacent samples.
   a. In one example, an index of the list may be signaled as a SE to indicate which set of non-adjacent samples is used to derive the model(s) of cross-component prediction.
      i. For example, the SE may be binarized as a truncated unary code.
      ii. In one example, the SE may be signaled conditionally. E.g. the SE is signaled only if NA-CCP is applied.
      iii. The SE may be signaled only if more than one sets of non-adjacent samples can be selected.
      iv. The maximum value (denoted as V) of the SE is determined by the number of sets of non-adjacent samples (denoted as K) to be selected.
         1) For example, V=K, or V=K-1, or V=K+1, or V=K−2, or V=K+2.
   b. In one example, the list may be constructed by checking multiple potential candidate regions in an order.
      i. The list is initialized to be empty.
      ii. The list construction is finished if the number of candidate regions in the list is equal to the maximum size of the list, such as 6.
      iii. The list construction is finished if all the potential candidate regions have been checked.
      iv. A potential candidate may be put into the list if the region is determined to be valid.
      v. Pruning may be applied to construct the list.
         1) A potential candidate may not be put into the list if it is “duplicated” with an existing candidate in the list.
         a) A candidate region is “duplicated” with another region if their samples are the same. (or similar).
         b) A candidate region is “duplicated” with another region if the same or similar models may be derived from samples in those two regions.
11. In one example, the position and/or dimensions of the region comprising the non-adjacent samples may depend on coding information, such as width/height of the current block.
   a. The region may be a potential candidate region for the list.
   b. The distance between the region and the current block may depend on width/height of the current block.
12. In one example, potential candidate regions may be M×N rectangles (e.g. M=N=8) non-adjacently left to/left below to/left above/above/right above the current block. FIG. 23 shows an example of potential candidate regions (shaded blocks).
13. In one example, a potential candidate region is a M×N (e.g. M=N=8) rectangle, and its top-left position (x0, y0) may be described as (suppose the top-left position of the current block with dimensions W×H is (0, 0)):
   a. (x0, y0)=(s*f(W, H), t*g(W, H)), wherein f and g are functions. s and t are scaling factors such as 0.5, 1 or 2.
   b. (x0, y0)=(s*f(W), t*g(H)), wherein f and g are functions. s and t are scaling factors such as 0.5, 1 or 2.
14. In one example, the potential candidate regions are M×N (e.g. M=N=8) rectangles, and their top-left positions in order are as below (suppose the top-left position of the current block with dimensions W×H is (0, 0)):
   (−xStep, 0),
   (0, −yStep),
   (xStep, −yStep),
   (−xStep, yStep),
   (−xStep, −yStep),
   (−2*xStep, 0),
   (0, −2*yStep),
   (−2*xStep, 2*yStep),
   (2*xStep, −2*yStep),
   (−2*xStep, yStep),
   (xStep, −2*yStep),
   (−2*xStep, −yStep),
   (−xStep, −2*yStep),
   (−2*xStep, −2*yStep),
   (−xStep/2, 0),
   (0, −yStep/2),
   (xStep/2, −yStep/2),
   (−xStep/2, yStep/2),
(−xStep/2, −yStep/2),
wherein xStep and yStep are integers.
   a. The checking order may be changed.
   b. In one example, xStep=Max (W, K1), yStep=Max (H, K2), wherein K1 and K2 are integers, e.g. K1=K2=16.
15. In one example, whether to and/or how to apply NA-CCP may be signaled from the encoder to the decoder.
   a. Alternatively, whether to and/or how to apply NA-CCP may be derived at encoder and decoder based on coded/decoded information without signaling.
   b. “How to apply NA-CCP” may comprise:
      i. Which CCP (such as CCLM or CCCM) model is derived by NA-CCP;
      ii. The shape/size/position of a (potential) candidate region;
      iii. The size of the region list;
      iv. The number of (potential) candidate regions;
      v. The color component to apply NA-CCP.
   c. “Coded/decoded information” may comprise:
      i. The mode of the current block;
      ii. The mode of a neighbouring block;
      iii. The mode of a luma block in the collocated region of the current block;
      iv. The mode of a luma block in the collocated region of a neighbouring block;
      v. QP;
      vi. Slice/picture type;
      vii. Picture width/height;
      viii. Block width/height;
      ix. Reconstructed samples.
16. In one example, the CCP coding information of a spatial or temporal neighbouring block may be used by the current block.
   a. For example, the spatial neighbouring block may be adjacent or non-adjacent to the current block.
   b. For example, the CCP coding information may comprise:
      i. The type of the CCP method, such as CCLM or CCCM or GLM or GLM with luma or GL-CCCM or CCCM using non-downsampled luma samples.
         1) In one example, GLM method using different down-sampling filters may be considered as different types.
         2) In one example, GLM with luma method using different down-sampling filters may be considered as different types.
         3) In one example, the types may be CCCM, CCLM, 4 types of GLM using different down-sampling filters, 4 types of GLM with luma using different down-sampling filters, GL-CCCM and CCCM using non-downsampled luma samples.
         4) “Not coded with CCP” (denoted as NonCCP) may also be treated as a type.
      ii. The position (x, y).
      iii. The number of models.
         1) For example, the number of models may be 1 or 2.
         2) In one example, the number of models may be considered as a part of the CCP type. For example, CCLM and MM-CCLM may be considered as two types.
      iv. At least one threshold to classify samples for different models.
         1) The threshold may be used only if the number of models is at least 2.
      v. At least one luma sample value offset.
         1) The luma sample value offset may be added to or subtracted from a luma sample (which may be down sampled) when it is used to derive a chroma prediction value.
         2) The luma sample value offset may be used only for specific types such as CCCM, GLM with luma, GL-CCCM and CCCM using non-down-sample luma samples.
      vi. At least one chroma sample value offset.
         1) The chroma sample value offset may be added to or subtracted from a chroma prediction value derived by a CCP model to generate the final prediction.
      vii. At least one models for at least one chroma component.
         1) For example, it may include different models for Cb and Cr components.
         2) For example, the number of models for each component may be included as a part of the information.
         3) The model may be represented by the model form of CCLM or CCCM or GLM or GLM with luma or GL-CCCM or CCCM using non-downsampled luma samples.
      viii. At least one sample location shift denoted as (dX, dY).
         1) The chroma sample location shift may be added to or subtracted from the sample location (x, y) when it is used to derive the chroma prediction value.
         2) The chroma sample location shift may be used only for specific types such as GL-CCCM.
   c. For example, the CCP coding information may be stored after a chroma block is coded/decoded.
      i. In one example, the CCP coding information may be stored only if the chroma block is coded with a CCP mode.
         1) In one example, the CCP coding information may be stored if the chroma block is coded with at least one CCP mode, such as with the fusion of chroma intra prediction mode.
         a) The stored type may be set to bethe CCP type used in the fusion of chroma intra prediction mode.
      ii. In one example, the CCP coding information may be stored for any chroma block.
         1) If the chroma block is not coded with a CCP mode, the type is stored as “NonCCP”.
      iii. If the chroma block is coded with a CCP mode, the type of information may be stored as depending on the coding mode.
         1) The type is set to be “CCCM” if the mode is CCCM, or CCCM-T, or CCCM-L, or MM-CCCM, or MM-CCCM-T, or MM-CCCM-L.
         2) The type is set to be “CCLM” if the mode is CCLM, or CCLM-T, or CCLM-L, or MM-CCLM, or MM-CCLM-T, or MM-CCLM-L.
         3) The type is set to be “CCLM” if the mode is CCLM, or CCLM-T, or CCLM-L, or MM-CCLM, or MM-CCLM-T, or MM-CCLM-L, with slope adjustments.
         4) The type is set to be “GLM using filter X” if the mode is GLM using filter X.
         5) The type is set to be “GLM with luma using filter X” if the mode is GLM with luma using filter X.
         6) The type is set to be “GL-CCCM” if the mode is GL-CCCM.
         7) The type is set to be “CCCM using non-down-sample” if the mode is CCCM using non-down-sample.
         8) The type is set to be “CCLM” if the mode is the fusion of chroma intra prediction mode.
      iv. The number of models may be stored as the number of models of the chroma block.
         1) For example, the number of models is set to be 2 if the mode is MM-CCLM, or MM-CCLM-T, or MM-CCLM-L, or MM-CCLM, or MM-CCLM-T, or MM-CCLM-L or any other multi-model CCP modes (such as GLM or GL-CCCM or CCCM using non-downsampled luma samples with multi-models).
      v. Information such as the threshold, the luma/chroma sample value offset, sample location shift may be stored as the information used by the chroma block.
      vi. The CCP model of one component may be stored as the model used by the chroma block.
         1) The model may be derived by any CCP method such as CCLM, or CCLM-T, or CCLM-L, or MM-CCLM, or MM-CCLM-T, or MM-CCLM-L or CCCM, or CCCM-T, or CCCM-L, or MM-CCCM, or MM-CCCM-T, or MM-CCCM-L or GLM using different down-sampling filters, or GLM with luma using different down-sampling filters, or GL-CCCM or CCCM using non-downsampled luma samples.
         2) The stored model may be the final applied one, such as the one after been modified by the slope adjustment.
   d. For example, the CCP coding information may be stored in M×N granularity.
      i. For example, M=N=2.
      ii. For example, the CCP coding information of a specific chroma block covered by or covering or overlapped with the M×N region may be stored to the M×N region.
         1) For example, the CCP coding information of the first coded/decode block with CCP information covered by or covering or overlapped with the M×N region may be stored.
         2) For example, the CCP coding information of the last coded/decode block with CCP information covered by or covering or overlapped with the M×N region may be stored.
         3) For example, the CCP coding information of the coded/decode block with CCP information covered by or covering or overlapped a specific position of the M×N region may be stored.
         a) The specific position may be the top-left/bottom-right/top-right/bottom-left/center position of the M×N region.
17. In one example, a CCP candidate list may be built for a chroma block.
   a. In one example, a first syntax element (SE) may be signaled to indicate whether a CCP candidate in the list is applied to the current chroma block. (It may be denoted as “The block is coded with the CCP candidate list mode”).
      i. For example, the SE may be a flag.
      ii. For example, the SE may be coded by a context.
   b. For example, the first SE may be signaled in a conditional way.
      i. For example, the first SE may be signaled only if CCP is applied.
      ii. For example, the first SE may be signaled only if CCP is applied, and a specific mode is applied.
         1) The specific mode may be CCLM.
         2) The specific mode may be CCCM.
   c. In one example, a second syntax element (SE) may be signaled to indicate which CCP candidate is applied.
      i. For example, the SE may be an index.
      ii. For example, the SE may be binarized as a truncated unary code.
         1) For example, the maximum value of the SE may be S−1, where S is the maximum size of the candidate list.
      iii. For example, the first bin of the SE may be coded by a context.
   d. For example, the second SE may be signaled in a conditional way.
      i. For example, the second SE may be signaled only if the first SE indicates a CCP candidate in the list is applied.
   e. In one example, whether the CCP candidate list mode is applicable may be signaled in VPS/DPS/SPS/PPS/picture header/slice header/etc.
   f. In one example, the maximum size/length of the CCP candidate list may be signaled in VPS/DPS/SPS/PPS/picture header/slice header/etc.
18. In one example, a CCP candidate list may comprise at least one CCP candidates stored in a spatial neighbouring block may be adjacent or non-adjacent to the current block (suppose the top-left position of the current block is (Xt, Yt), the width and height of the current block is W and H, respectively.
   a. In one example, a set of positions are checked in order to find stored CCP information.
      i. For example, if the type of the stored CCP information associated with the position is NonCCP, the position is skipped.
         1) Alternatively, if the type of the stored CCP information associated with the position is NonCCP, the position is put in a backup position list.
      ii. For example, if the type of the stored CCP information associated with the position is NOT NonCCP, the stored CCP information is tried to be appended to the list.
   b. In one example, the set of positions (Xi, Yi) to be checked in order may be derived from positions near to the current block, to positions far from the current block.
      i. For example, the positions may be checked in a cycle by cycle manner. For a cycle, several positions are checked, and the next cycle is performed.
      ii. In one example, positions to be checked in a cycle are:

$$( Xt - NDHor - 1 , Yt + H + N D V e r - 1 ) , ( Xt + W + N D H o r - 1 , Yt - NDVer - 1 ) , ( Xt + ( W >> 1 ) , Yt - NDVer - 1 ) , ( Xt - NDHor - 1 , Yt + ( H >> 1 ) ) , ( Xt - NDHor - 1 , Yt - NDVer - 1 ) .$$

where NDHor and NDVer are different for different cycles.
iii. In one example, positions to be checked for the cycle k are derived as:

$$\begin{matrix}NDHor = ( k == 0 ? W / 2 : W * k ) ; \\ NDVer = ( k == 0 ? H / 2 : H * k ) ;\end{matrix}$$

iv. In one example, positions to be checked for different cycle may be different.
c. In one example, the set of positions (Xi, Yi) to be checked may be the same as the set of positions checked when building the merge list.
d. In one example, the set of positions (Xi, Yi) to be checked may be the same as the set of positions checked when building the sub-block-based merge list.
19. In one example, when trying to put stored CCP information into the CCP candidate list as a candidate (known as a potential candidate), it may be compared with at least one candidate already in the CCP candidate list.
   a. In one example, all the candidates in the list may be compared with the potential candidate.
   b. In one example, if a candidate already in the CCP candidate list is the same or similar as the potential candidate, then potential candidate cannot be put into the CCP candidate list.
   c. In one example, two CCP candidates are determined NOT to be the same if:
      i. The CCP types are different.
      ii. The numbers of models are different.
      iii. The thresholds are different if the CCP has multiple models.
      iv. At least one model is different.
      v. The luma sample offset is different. (maybe only applicable if the type is CCCM or GL-CCCM or GLM or CCCM with using non-downsampled luma samples.).
      vi. The sample location shifts are different. (maybe only applicable if the type is GL-CCCM).
   20. In one example, when a CCP candidate in the list is used to generate prediction for the current block, the CCP will be performed following the CCP information.
      a. CCCM, CCLM, 4 types of GLM using different down-sampling filters, 4 types of GLM with luma using different down-sampling filters, GL-CCCM and CCCM using non-downsampled luma samples may be applied to the current block, based on the CCP type of the candidate.
      b. One model or multiple models with at least one threshold may be used, based on the model number and thresholds of the candidate.
      c. The luma sample value offset of the candidate may be added to or subtracted from the luma samples (which may be down-sampled) to be put into the CCP model.
      i. The process may be only applicable if the type is CCCM or GL-CCCM or GLM or CCCM with using non-downsampled luma samples.
   d. The sample location shift(s) may be added to or subtracted from the location coordinator to be put into the CCP model.
      i. The process may be only applicable if the type is GL-CCCM.
   e. How to get down-sampled luma samples may be based on the CCP type.
      i. The down-sampled luma samples may be obtained following the down-sampling method required by the CCP mode corresponding to the type.
21. In example, the prediction value generated by a CCP candidate may be modified before being used to obtain the reconstruction sample value.
   a. In one example, an offset D may be added to or subtracted from the prediction value.
   b. In one example, the offset may be derived based on luma/chroma samples of a template, which is calculated using reconstructed samples neighbouring to the current block, known as a “template”. FIG. 24 shows examples of a template.
      i. In one example, the template may consist of reconstructed samples left to the current block, if reconstructed samples left to the current block are available.
      ii. In one example, the template may consist of reconstructed samples above to the current block, if reconstructed samples above to the current block are available.
      iii. In one example, the template may consist of reconstructed samples above or left to the current block, if reconstructed samples above/left to the current block are available.
      iv. Corresponding luma samples of the template may be down-sampled with the same manner as luma samples inside the current block.
   c. In one example, if there are N models (such as two models) required by the CCP type, N offsets denoted as {D°, . . . , DN−1} may be derived for the N models.
      i. Offset Dⁱ may be added to or subtracted from the prediction value generated by model i.
   d. In one example, the CCP method indicated by the type of the CCP candidate may be applied on the template.
      i. For example, for the k-th sample of the template, Sₖ=Rₖ−Pₖ is calculated, where Rₖ and Pₖ represent the reconstructed sample value and the prediction value with CCP of the k-th sample, respectively, is calculated.
         1) For example, D is calculated as the average value of {Sₖ}.
         2) For example, suppose the number of Sₖ is M, D is calculated as D=sign(sum)×((|sum|+off)>>W), where

$$sum = {\sum }_{k = 0}^{M - 1} {S}_{k}$$

and W=└ log₂|sum|┘.
ii. For example, for the k-th sample using model i of the template, Sⁱₖ=Rⁱₖ−Pⁱₖ is calculated, where Rⁱₖ and Pⁱₖ represent the reconstructed sample value and the prediction value with CCP of the k-th sample using model i, respectively, is calculated.
   1) For example, Dⁱ is calculated as the average value of {Sⁱₖ}.
   2) For example, suppose the number of Sⁱₖ is M, D is calculated as Dⁱ=sign(sum)×((|sum|+off)>>W), where

$$sum = {\sum }_{k = 0}^{M - 1} {S}_{k}^{i}$$

and W=└ log₂|sum|┘.
iii. In one example, no division operation is used to calculate D or Dⁱ.
   1) For example, a lookup table may be used to calculate D or Dⁱ.
e. For example, only specific types of CCP may apply the modifications, such as CCLM and CCCM with multiple models.
   i. For example, types of CCLM, CCLM with multiple models, CCCM with multiple models, and GLM may apply the modifications.
22. In one example, a candidate with type “Non-adjacent” may be put into the candidate list.
   a. The information includes a position (x, y).
   b. If such a candidate is used to predict the current block, CCP model(s) may be derived with samples referred to by (x, y), as described in bullet 1˜bullet 15.
   c. In one example, the positions stored in the backup position list disclosed in bullet 18 may be checked in order to put valid ones in the candidate list.
23. In one example, the construction of the candidate list may be terminated if the number of candidates in the list is M and M=D+1, wherein D is the index indicating the selected candidate.
24. In one example, if all possible potential candidates are checked and the size of the candidate list is smaller than S, wherein S is the maximum number of candidates, then default candidates may be put into the list to fulfill the list.
25. In one example, the CCP candidate list may comprise at least one candidate fetched from a history-based table.
   a. The history table may be an online table.
   b. The history table may be a stored table.
   c. To build the CCP candidate list, the potential candidates may be checked in an order.
      i. For example, the order may be (1) CCP information stored in spatial adjacent/non-adjacent blocks; (2) CCP candidate with type “Non-adjacent; (3) history-based candidates from the on-line table; (4) history-based candidates from the stored table; (5) default candidates.
      ii. For example, the order may be (1) CCP information stored in spatial adjacent blocks; (2) CCP information stored in spatial non-adjacent blocks; (3) CCP candidate with type “Non-adjacent; (4) history-based candidates from the on-line table; (5) history-based candidates from the stored table; (6) default candidates.
      iii. For example, the order may be (1) CCP information stored in spatial adjacent blocks; (2) CCP information stored in spatial non-adjacent blocks; (3) history-based candidates from the on-line table; (4) history-based candidates from the stored table; (5) CCP candidate with type “Non-adjacent; (6) default candidates.
      iv. For example, the order may be (1) CCP information stored in spatial adjacent blocks; (2) history-based candidates from the on-line table; (3) CCP information stored in spatial non-adjacent blocks; (4) CCP candidate with type “Non-adjacent; (5) history-based candidates from the stored table; (6) default candidates.
      v. Any type of candidates in an exemplary order may be removed from.
      vi. Any other orders of these kinds of potential candidates.
26. In one example, if a chroma block is coded by using at least one CCP candidate, the CCP information of the CCP candidate may be stored.
   a. The storing method may follow the way disclosed in bullet 16.
27. In one example, if a chroma block is coded by using at least one CCP candidate, the CCP information of the CCP candidate may be put into the history-based table.
   a. The process to put the CCP information into the history-based table may follow the process described in section 2.27.

### 3. Problems

There are several issues in the existing video coding techniques, which would be further improved for higher coding gain.
1. In ECM (e.g., up to ECM-8.0), different intra chroma modes are explicitly signalled in the bitstream. However, implicit derivation may be applied for higher coding efficiency.
2. In ECM (e.g., up to ECM-8.0), intra chroma fusion is used to fuse a nonLM mode with a MMLM_TL mode, or fuse a nonLM mode with a luma value. However, it may be further improved.
3. The prediction of multi-model based cross-component prediction modes may be further filtered.
4. Assume a non-local cross-component prediction (CCP) mode (or, a cross-component merge (CCMerge) mode) is allowed in the codec, in which CCP model parameters the current chroma block can be inherited from an adjacent/non-adjacent neighbor block coded with CCP. How to interact the non-local CCP mode with prediction filtering CCP mode, and/or template cost CCP mode may be further considered.
5. In ECM, similarity check may be applied for the comparison between two motion/mode candidates, and the coding information of a reference block may be stored as the current block's motion/mode information. In such case, how to perform the similarity check may be redesigned.
6. In ECM, temporal candidates are not used for intra mode coding, however, CCP candidates and intra mode information can be derived from a temporal video unit.

### 4. Detailed Solutions

The detailed solutions below should be considered as examples to explain general concepts. These solutions should not be interpreted in a narrow way. Furthermore, these solutions can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

The term “LM” may refer to any linear/non-linear regression based method, such as CCLM, MMLM, CCCM, GL-CCCM, CCCM without downsampling, CCCM-MDF, GLM, GLM with luma value, etc. It may also be referred as the term “cross-component prediction (CCP)”.

The term “CCLM” may refer to a single model LM mode, it could be single model CCLM, single model CCCM, single model GL-CCCM, single model CCCM without downsampling, single model CCCM-MDF, single model GLM, single model GLM with luma value, etc.

The term “MMLM” may refer to a multi-model LM mode, it could be multi-model CCLM, MMLM, multi-model CCCM, multi-model GL-CCCM, multi-model CCCM without downsampling, multi-model CCCM-MDF, multi-model GLM, multi-model GLM with luma value, etc.

The term “CCLM_TL” may refer to a single model LM mode which takes use of both left and above neighboring samples.

The term “MMLM_TL” may refer to a multi-model LM mode which takes use of both left and above neighboring samples.

The term “CCLM_L” may refer to a single model LM mode which takes use of only left neighboring samples.

The term “MMLM_L” may refer to a multi-model LM mode which takes use of only left neighboring samples.

The term “CCLM_T” may refer to a single model LM mode which takes use of only above neighboring samples.

The term “MMLM_T” may refer to a multi-model LM mode which takes use of only above neighboring samples.

The term “CCCM” may refer to a regular CCCM mode, or a GL-CCCM mode, or a CCCM without downsampling, or a CCCM-MDF mode.

The term “GL-CCCM” may refer to a CCCM mode which considers gradients and locations of involved samples.

The term “CCCM w/o downsampling” may refer to a CCCM mode which considers non-downsampled luma samples.

The term “CCCM-MDF” may refer to a CCCM mode based on multiple downsampling filters.

In the document, cross-component prediction (CCP) may refer to any cross-component prediction method such as any kind of CCLM/CCCM/GLM/GL-CCCM/CCCM-MDF/CCCM without downsampling.

In the document, a cross-component merge (CCMerge) mode may refer to a cross-component prediction which inherits coding information from a previously coded video unit.

It is noted that the terminologies mentioned below are not limited to the specific ones defined in existing standards. Any variance of the coding tool is also applicable.

4.1 about Implicit Mode Decision and Related Issues (e.g., the First Problem), the Following Methods are Proposed:
a. A template-cost-based method may be used for a certain intra/inter/IBC mode decision.
   a. For example, a mode or coding method or any setting may be applied to luma and/or chroma samples neighbouring to the current block to obtain a first prediction on the neighbouring samples.
   b. A distortion (such as SAD) between the reconstructed neighbouring samples and predicted neighbouring samples is derived as the cost for the first mode or coding method or any setting.
      i. For example, the predicted neighbouring samples may be derived based on a CCP model.
   c. The mode or coding method or any setting with a minimum cost may be determined to be the selected.
   d. In one example, the determination may be performed for different components (such as Cb and Cr) together.
      i. The cost may be calculated with one of the components.
      ii. The cost may be calculated with multiple components (such as Cb and Cr).
      iii. Different components may share the same determined mode/method/setting.
      iv. For example, the cost/distortion of Cb and Cr may be accumulated together, and a model or mode decision may be applied based on the accumulated cost/distortion.
   e. In one example, the determination may be performed for different components (such as Cb and Cr) separately.
      i. Different components may have different determined mode/method/setting.
   f. For example, whether to apply an intra chroma mode to the current video unit may be determined based on template cost.
   g. For example, how to choose a weight/blend/fusion method to the current video unit may be determined based on template cost.
   h. For example, whether and/or how to fuse two chroma prediction blocks may be based on template cost.
      i. For example, whether to fuse a nonLM chroma mode with a regular MMLM or a regular CCCM based MMLM mode or a GL-CCCM based MMLM mode, may be based on template cost.
      ii. For example, a final chroma prediction may be generated based on fusing a nonLM chroma mode with a CCP mode, and which CCP mode is fused may be determined based on template cost.
         1. For example, the CCP mode may be a CCLM mode, and/or a regular CCCM mode, and/or a GL-CCCM mode, and/or a CCCM without downsampling, and/or a CCCM-MDF mode.
   i. For example, the number of reference lines used to solve the linear/non-linear/polynomial model/equation for a certain intra/inter/IBC mode may be determined based on template cost.
      i. For example, whether to use M1 or M2 lines of reference samples to derive the model for a cross-component prediction mode (e.g., GLM mode) may be determined based on template cost.
   j. For example, how to separate/classify training samples for different models of the cross-component prediction mode (e.g., whether to use neighboring luma samples or collocated luma samples to derive a threshold for the categorization, etc.) may be determined based on template cost.
      i. For example, whether to use block vector guided reference samples to derive a threshold for the categorization may be determined based on template cost.
         1. For example, the block vector may be derived based on a luma block vector.
      ii. For example, the CCP mode may be a CCLM mode, a regular CCCM mode, a GL-CCCM mode, a CCCM without downsampling, or a CCCM-MDF mode.
   k. For example, the reference region used to solve the linear/non-linear/polynomial model/equation for a certain CCP mode may be determined based on template cost.
      i. For example, whether to use M1 or M2 rows/columns of reference samples to derive a CCP model may be determined based on template cost.
      ii. For example, whether to use neighboring samples or block vector guided reference samples to derive a CCP model may be determined based on template cost.
      iii. For example, the CCP mode may be a CCLM mode, a regular CCCM mode, a GL-CCCM mode, a CCCM without downsampling, or a CCCM-MDF mode.
b. For example, if the proposed method is applied to a GL-CCCM mode, the location terms which represent the location of a template sample may be derived based on the reference area used for GL-CCCM model calculation.
   a. For example, assume the top-left corner of reference area is denoted as (x0,y1) and the top-left position of the current video unit is denoted as (x0+refSizeX, y0+refSizeY), wherein refSizeX and refSizeY indicate the reference size in width and height, respectively, then the location term of the template samples may be calculated relative the top-left corner of reference area (e.g., even if the template location may or may not be relevant to the reference area).
      i. For example, the same reference area may be used for GL-CCCM model calculation and model application/deployment.
c. For example, if the proposed method is applied to a certain CCCM mode which uses location information, the location terms of a template sample may be derived based on the location relative to the reference area.
   a. For example, the certain CCCM mode may be GL-CCCM, or CCCM-MDF.
   b. For example, the reference area used for template cost derivation and the CCP model derivation may be the same.
d. For example, if the proposed method is applied to a GLM mode, at least one of the following conditions may be satisfied.
   a. The GLM mode considers both gradient and luma value for model calculation.
   b. The GLM mode considers non-downsampled luma value for model calculation.
   c. The model parameters of the GLM mode may be derived from a gaussian elimination solver (or an LDL based solver).
e. Whether left or above template is used for template cost calculation may be based on the prediction mode.
   a. For example, for CCLM_T/MMLM_T mode, only above template is used for template cost calculation.
      i. For example, furthermore, even if left template is available, the left template may not be used to calculate the template cost for CCLM_T/MMLM_T mode.
      ii. For example, the CCLM_T/MMLM_T may be regular CCLM_T/MMLM_T mode.
      iii. For example, the CCLM_T/MMLM_T may be CCCM based CCLM_T/MMLM_T mode.
      iv. For example, the CCLM_T/MMLM_T may be GLM based CCLM_T/MMLM_T mode.
   b. For example, for CCLM_L/MMLM_L mode, only left template is used for template cost calculation.
      i. For example, furthermore, even if above template is available, the above template may not be used to calculate the template cost for CCLM_L/MMLM_L mode.
      ii. For example, the CCLM_L/MMLM_L may be regular CCLM_L/MMLM_L mode. the CCLM_L/MMLM_L may be CCCM based iii. For example, CCLM_L/MMLM_L mode.
      iv. For example, the CCLM_L/MMLM_L may be GLM based CCLM_L/MMLM_L mode.
f. Both left and above templates may be used to derive the template cost.
   a. For example, for CCLM_TL/MMLM_TL mode, both left and above templates may be used to derive the template cost.
   b. For example, the CCLM_TL/MMLM_TL may be a regular CCLM_TL/MMLM_TL mode.
   c. For example, the CCLM_TL/MMLM_TL may be a CCCM based CCLM_TL/MMLM_TL mode.
   d. For example, the CCLM_TL/MMLM_TL may be a GLM based CCLM_TL/MMLM_TL mode.
g. Whether left or above template is used for template cost calculation may be based on the availability of the neighboring samples.
   a. For example, if a neighboring sample is not available, another sample value may be used instead.
   b. Alternatively, if left or above template is not available, the template cost may be calculated based on the above or left template.
h. Whether left or above template is used for template cost calculation may be based on based on the location of the current video unit (e.g., whether it is at the CTU/VPDU top boundary, etc.).
a. For example, the above template may not be used if the current video unit locates at the first row of the CTU.
i. For example, the template size may be greater than one line.
   a. For example, the template size may be greater than one line, regardless of the CTU top boundary restriction.
   b. Alternatively, the template size may be one row above the current video unit and/or one column left to the current video unit.
j. For example, the proposed method may be used to a cross-component prediction mode.
   a. For example, the cross-component prediction mode may be a GLM/CCLM/MMLM/CCCM/GL-CCCM/CCCM w/o subsampling/CCCM-MDF mode.
   b. For example, the cross-component prediction mode may be single-model based.
   c. For example, the cross-component prediction mode may be multi-model based.
   d. For example, the cross-component prediction mode may take use of both top and left templates.
   e. For example, the cross-component prediction mode may take use of top or left template only.
k. For example, the proposed method may be used to an intra chroma fusion mode (multi-model based, single-model based, etc.).
   a. For example, it may be used to intra chroma fusion which fuses a non-LM chroma prediction with a certain LM chroma prediction (such as CCCM or CCLM).
   b. For example, it may be used to intra chroma fusion which fuses a non-LM chroma prediction with a downsampled luma reconstruction.
l. For example, the proposed method may be used to an intraTMP mode (e.g., fused intraTMP).
m. For example, the proposed method may be used to a fusion mode (e.g., MHP, intra luma fusion, DIMD fusion, TIMD fusion, template BCW, etc.).
n. For example, the proposed method may be used to an LIC mode.
o. For example, whether and/or how to apply a template-cost-based method to a video unit may be based on the slice type and/or partition way.
   a. For example, it may be based on whether it is an intra slice (i.e., I slice).
   b. For example, it may be based on whether it is dual tree.
   c. For example, a certain template-cost-based method may be allowed only for I slices.
      i. Alternatively, the template-cost-based method may not be allowed for I slices (i.e., only allowed for B/P slices).
   d. For example, the template-cost-based method may be related to intra chroma fusion.
   e. For example, the template-cost-based method may be related to reference range selection for an LM mode.
   f. For example, the template-cost-based method may be related to multi-model separation/division/classification for an LM mode.
p. The usage/allowance of a template-cost-based method may be dependent on the type of template used by the CCP mode.
   a. In one example, it may be dependent on whether an extended template is used.
   b. In one example, whether a certain template-cost-based method is used may be dependent on a syntax element related to template type.
q. The usage/allowance of a template-cost-based method may be dependent on the downsampling filter used by the CCP mode.
   a. In one example, it may be dependent on whether a certain downsampling filter mode is used.
   b. In one example, it may be dependent on whether multiple downsampling filtering mode is used.
   c. In one example, it may be dependent on a syntax element related to the downsampling filter type.
      i. For example, it may be dependent on the downsampling filter index (e.g., assume more than one downsamping filter is allowed for the CCP mode).
      ii. For example, it may be dependent on the multiple downsampling filter mode.
r. The usage/allowance of a template-cost-based method may be based on the usage of CCCM-MDF mode.
   a. For example, a template cost based method may NOT be used to determine the reference region for a CCCM-MDF mode.
   b. For example, a template cost based method may NOT be used to determine the multi-model categorization threshold for a CCCM-MDF mode.
   c. For example, a rule above may be applied to all kinds of CCCM-MDF mode.
      i. Alternatively, a rule above may be applied to a certain CCCM-MDF mode (e.g., not all kinds of CCCM-MDF modes in case that more than one applicable CCCM-MDF mode is allowed in the codec).
         4.2 about Intra Chroma Fusion and Related Issues (e.g., the Second Problem), the Following Methods are Proposed:
a. A nonLM chroma prediction block may be fused with another CCCM based MMLM mode predicted block.
   a. For example, the CCCM may be GL-CCCM.
   b. For example, the CCCM may be CCCM w/o downsampling.
   c. For example, the CCCM may be regular CCCM.
   d. For example, the CCCM may be CCCM-MDF.
b. A nonLM chroma prediction block may be fused with another GLM based MMLM mode predicted block.
   a. For example, the GLM may be multi-model based.
   b. For example, the GLM may be based on luma gradient and/or luma reconstruction value.
c. Furthermore, how to separate training samples for the two models of the MMLM (e.g., whether to use neighboring luma samples or collocated luma samples to derive a threshold for the categorization, etc.) may be determined based on template cost.
   a. For example, a chroma prediction block is generated by the MMLM mode and used for intra chroma fusion.
   b. For example, the MMLM mode may be a regular MMLM-TL mode, or a regular CCCM based MMLM_TL mode, or a GL-CCCM based MMLM_TL mode, or a CCCM w/o downsampling based MMLM_TL mode, or a CCCM-MDF based MMLM-TL mode, or a GLM based MMLM_TL mode.
d. The blending/fusion of the two chroma prediction blocks may be based on sample-based weights (rather than block based weights).
e. The blending/fusion weights of the two chroma prediction blocks may be calculated based on a gaussian elimination solver (or LDL decomposition solver).
   a. For example, the solver may be based on more than one line of neighboring samples.
   b. For example, how may lines of reference samples are taken used for the solver may be determined by a template cost.
f. The prediction of the MMLM based prediction block may be firstly filtered then fused with the nonLM chroma prediction block.
   a. For example, whether to filter the prediction of the MMLM based prediction block may be determined based on template cost.
   b. Alternatively, whether to filter the prediction of the MMLM based prediction block may be signalled in the bitstream.
g. For example, more than one hypothetic prediction may be allowed/used/applied to be fused with a nonLM chroma prediction.
   a. For example, M (such as M=2, or 3 or 4, etc.) hypothetic predictions may be allowed or used or applied.
   b. For example, more than one hypothetic prediction may be fused with a nonLM chroma prediction.
      i. For example, the final prediction of the video unit may be derived based on a weighted sum of all hypothetic predictions and the nonLM chroma prediction.
   c. For example, one hypothetic prediction is finally chosen to be fused with a nonLM chroma prediction.
      i. For example, the final prediction of the video unit may be derived based on a weighted sum of the selected hypothetic prediction and the nonLM chroma prediction.
      ii. For example, which hypothetic prediction is chosen to be fused with a nonLM chroma prediction may be determined based on template cost.
   d. For example, template cost (e.g., SAD, SATD) may be calculated for each of the models or hypothetic predictions, e.g., by applying each model to a pre-defined template.
      i. For example, the template may be comprised by left and/or above reconstruction/prediction samples (e.g., luma and/or chroma) neighboring to the current luma and/or chroma block.
      ii. For example, the template size may be at least one row and/or one above samples.
         1. For example, the template size may be greater than one row and/or one above samples.
      iii. For example, distortions/costs may be measured by accumulating the difference between the prediction (e.g., neighboring predicted chroma values obtained based on the pre-calculated model) and the reconstruction (e.g., neighboring reconstructed chroma values already decoded) of template samples.
      iv. For example, the model information which achieve the minimum distortion/cost may be chosen as the final model, and by using such model, a prediction is generated and fuse with a nonLM chroma prediction.
   e. For example, for each prediction element (e.g., a hypothetic prediction, a nonLM prediction, etc.) participating in the chroma fusion, the weight may be determined based on template cost and/or decoding information.
      i. For example, it may be determined based on the availability of neighboring samples.
      ii. For example, it may be determined based on the prediction mode of neighboring samples.
         1. For example, it may be based on whether a neighbor is LM coded.
      iii. For example, if the template cost is greater than a threshold, larger weight factor may be applied to the nonLM prediction. Otherwise, smaller weight factor may be applied to the nonLM prediction.
         1. For example, the threshold may be derived based on the block width and/or height.
   f. For example, a hypothetic prediction may be a luma prediction block.
   g. For example, a hypothetic prediction may be a downsampled luma reconstruction block.
   h. For example, a hypothetic prediction may be derived based on cross-component chroma prediction mode.
      i. For example, a hypothetic prediction may be derived based on a GL-CCCM based MMLM.
      ii. For example, a hypothetic prediction may be derived based on a CCCM without subsample based MMLM.
      iii. For example, a hypothetic prediction may be derived based on a CCCM-MDF based MMLM.
      iv. For example, a hypothetic prediction may be derived based on a regular CCCM (i.e., CCCM with subsample) based MMLM.
      v. For example, a hypothetic prediction may be derived based on a regular CCLM based MMLM.
   i. For example, for a hypothetic prediction, a model may be built, and the corresponding model coefficients may be calculated based on the relationship between luma and chroma samples from neighbors.
   j. For example, for a hypothetic prediction, model information may include a hypothetic chroma mode (e.g., MMLM, CCLM, CCCM, GL-CCCM, CCCM with subsample, CCCM without subsample, CCCM-MDF, etc.) and calculated model coefficients.
h. For example, whether and/or how to apply intra chroma fusion to a video unit may be based on the slice type and/or partition way.
   a. For example, it may be based on whether it is an intra slice (i.e., I slice).
   b. For example, it may be based on whether it is dual tree.
   c. For example, the template cost based intra chroma fusion may be allowed only for I slices.
      i. Alternatively, the template cost based intra chroma fusion may not be allowed for I slices (i.e., only allowed for B/P slices).
   d. For example, intra chroma fusion with more than one hypothetic LM predictions may be allowed only for I slices.
      i. Alternatively, it may not be allowed for I slices (i.e., only allowed for B/P slices).
i. How to separate samples (e.g., whether to use neighboring luma samples or collocated luma samples to derive a threshold for the categorization, etc.) for multiple model modulation during an intra chroma fusion process, may be determined based on template cost.
   a. For example, the intra chroma fusion process may be related to fuse a non-LM chroma prediction with a downsampled luma reconstruction.
   b. Furthermore, for example, the intra chroma fusion process may be conducted based on two models, wherein one model is built/applied based on samples belong to category-A, the other model is built/applied based on samples belong to category-B.
      i. For example, how to separate samples into category-A or category-B may be dependent on a threshold.
         1. Furthermore, for example, the threshold may be based on neighboring sample values.
         2. Furthermore, for example, the threshold may be based on collocated luma sample values.
         3. Furthermore, for example, whether the threshold is derived based on neighboring sample values or collocated luma sample values may be dependent on a decoder side template-cost based method.
         a. For example, the template cost may be based on differences between the predicted template sample values and the real reconstruction values of samples in the template, wherein the predicted template sample values may be calculated by applying the multi-model intra chroma fusion to the template samples.
j. How to select training samples for linear/non-linear model modulation during a intra chroma fusion process, may be determined based on template cost.
   a. For example, the intra chroma fusion process may be related to fuse a non-LM chroma prediction with a downsampled luma reconstruction.
   b. Furthermore, for example, the prediction fusion process may be conducted based on a linear/non-linear model trained from some reference samples.
      i. For example, how many rows and/or columns of reference samples are selected for training, may be determined based on a template cost.
      ii. For example, M (e.g., M=6) or N (e.g., N=2) rows and/or columns of reference samples may be selected, determined based on template cost.
      iii. For example, the template cost may be based on differences between the predicted template sample values calculated by model A and the predicted template sample values calculated by model B, wherein model A and model B are modulated from different rows/columns of training samples.
k. The usage/allowance of intra chroma fusion may be dependent on the type of template used by the CCP mode.
   a. In one example, it may be dependent on whether an extended template is used.
   b. In one example, whether a certain intra chroma fusion mode is used may be dependent on a syntax element related to template type.
l. The usage/allowance of intra chroma fusion may be dependent on the downsampling filter used by the CCP mode.
   a. In one example, it may be dependent on whether a certain downsampling filter mode is used.
   b. In one example, it may be dependent on whether multiple downsampling filtering mode is used.
   c. In one example, it may be dependent on a syntax element related to the downsampling filter type.
      i. For example, it may be dependent on the downsampling filter index (e.g., assume more than one downsamping filter is allowed for the CCP mode).
      ii. For example, it may be dependent on the multiple downsampling filter mode.
m. For example, a CCCM-MDF prediction may NOT be used for the intra chroma fusion.
   a. Alternatively, prediction of all kinds of CCCM-MDF modes may be allowed for intra chroma fusion.
   b. Alternatively, a certain CCCM-MDF mode may be allowed for the intra chroma fusion process (e.g., not all kinds of CCCM-MDF modes are allowed for intra chroma fusion, in case that more than one applicable CCCM-MDF mode is allowed in the codec).
      4.3 about Prediction Block Filtering and Related Issues (e.g., the Third Problem), the Following Methods are Proposed:
a. Whether the prediction block of a cross component prediction (CCP) coded video unit is filtered may be dependent on the type of the CCP mode.
   a. For example, it may be filtered if the CCP mode is multi-model based.
   b. For example, it may be filtered if the CCP mode is a CCCM mode (e.g., regular CCCM, and/or GL-CCCM, and/or CCCM without downsampling).
   c. For example, it may not be filtered if the CCP mode is a CCCM w/o subsampling mode.
   d. For example, it may not be filtered if the CCP mode is a GL-CCCM mode.
b. How to signal the prediction block filtering flag for a cross component prediction (CCP) coded video unit may be dependent on the type of the CCP mode.
   a. For example, it may be signalled conditioned on whether the CCP mode is a CCCM w/o subsampling mode.
      i. For example, if the CCP mode is a CCCM w/o subsampling mode, the prediction block filtering flag may not be signalled (e.g., inferred to be not used.).
   b. For example, it may be signalled conditioned on whether the CCP mode is a GL-CCCM mode.
      i. For example, if the CCP mode is a GL-CCCM mode, the prediction block filtering flag may not be signalled (e.g., inferred to be not used.).
   c. For example, it may be signalled conditioned on whether the CCP mode is a GLM mode.
      i. For example, if the CCP mode is a GLM mode, the prediction block filtering flag may not be signalled (e.g., inferred to be not used.).
c. For example, whether and/or how to apply prediction block filtering to a video unit may be based on the slice type and/or partition way.
   a. For example, it may be based on whether it is an intra slice (i.e., I slice).
   b. For example, it may be based on whether it is dual tree.
   c. For example, prediction block filtering may be allowed only for I slices.
      i. Alternatively, prediction block filtering may not be allowed for I slices (i.e., only allowed for B/P slices).
d. Whether the prediction block of a cross component prediction (CCP) coded video unit is filtered may be dependent on the type of template used by the CCP mode.
   a. In one example, it may be dependent on whether an extended template is used.
   b. In one example, the prediction filtering may not be allowed for a CCP mode that uses an extended template.
   c. In one example, the prediction filtering may not be allowed for a CCP mode that NOT uses an extended template.
   d. In one example, whether the prediction filtering is allowed to be used may be dependent on a syntax element related to template type.
      i. For example, the signalling of prediction filter mode may be based on (e.g., conditioned by) the syntax element related to template type.
e. Whether the prediction block of a cross component prediction (CCP) coded video unit is filtered may be dependent on the downsampling filter used by the CCP mode.
   a. In one example, it may be dependent on whether a certain downsampling filter mode is used.
   b. In one example, it may be dependent on whether multiple downsampling filtering mode is used.
   c. In one example, whether the prediction filtering is allowed/signalled to be used may be dependent on a syntax element related to the downsampling filter type.
      i. For example, it may be dependent on the downsampling filter index (e.g., assume more than one downsamping filter is allowed for the CCP mode).
      ii. For example, it may be dependent on the multiple downsampling filter mode.
f. The prediction of a CCCM-MDF mode may be further filtered by a certain filtering method.
   a. For example, whether the prediction of a CCCM-MDF mode is further filtered may be signalled in the bitstream.
      i. For example, the signalled syntax element may be dependent on whether MMLM_TL mode is used.
   b. For example, a same syntax element may be used to signal the prediction filtering status of CCCM-MDF mode and another CCP mode (e.g., MMLM, CCCM, GL-CCCM, CCCM without downsampling, etc).
   c. For example, prediction block of all kinds of CCCM-MDF modes may be allowed to be further filtered by the filtering method.
      i. Alternatively, the filtering method may be applied to a certain CCCM-MDF mode (e.g., not all CCCM-MDF modes in case that more than one applicable CCCM-MDF mode is allowed in the codec).
g. The signalling of the syntax element (e.g., a flag) indicating whether a CCP prediction is further filtered may be conditioned on the usage of a CCCM-MDF mode.
   a. For example, the syntax element may be only signalled when a CCCM-MDF mode is not used to the current video unit.
   b. For example, the prediction of a CCCM-MDF mode may be never filtered by the certain prediction filtering process.
   c. For example, it may be conditioned on a certain CCCM-MDF mode (e.g., not all kinds of CCCM-MDF modes in case that more than one applicable CCCM-MDF mode is allowed in the codec).
      4.4 about the Interaction with Different CCP Modes and Related Issues (e.g., the 4th Problem), the Following Methods are Proposed:
a. In one example, at least one piece of coding information of a CCP coded video unit may be stored and utilized by a subsequent coding process.
   i. In one example, whether the prediction of a CCP coded unit is filtered may be stored.
   ii. In one example, the CCP model parameters for different color components (e.g., Cb and Cr) of a CCP coded video unit may be stored independently.
      a) For example, the CCP model type (e.g., CCLM, CCCM, CCCM w/o downsampling, GL-CCCM, CCCM-MDF, etc.) may be different for Cb and Cr.
         a. Alternatively, one CCP model type may be stored for both Cb and Cr components of a CCP coded video unit.
      b) For example, the threshold(s) for categorizing samples into different groups of a multi-model CCP mode may be stored independently for Cb and Cr.
         a. Alternatively, one threshold may be stored for both Cb and Cr components of a CCP coded video unit.
      c) For example, whether to use single model or multi-model may be stored independently for Cb and Cr.
         a. Alternatively, either signle model or multi-model may be stored for both Cb and Cr components of a CCP coded video unit.
      d) For example, the prediction filtering status may be stored independently for Cb and Cr.
         a. Alternatively, one prediction filtering status may be stored for both Cb and Cr components of a CCP coded video unit.
   iii. In one example, for a prediction filtering CCP mode coded video unit, at least one of the following information may be stored.
      a) CCP model type for Cb and Cr, respectively (or, jointly).
      b) CCP model parameters/coefficients for Cb and Cr, respectively (or, jointly).
      c) threshold(s) for categorizing samples into different groups for Cb and Cr, respectively (or, jointly), if a multi-model CCP mode is applied.
      d) Whether the prediction of this CCP coded block is filtered by a certain filter, for Cb and Cr, respectively (or, jointly).
   iv. In one example, the information may be stored in a buffer.
      a) In one example, the information may be stored associated with the mode/motion information for each video block.
      b) In one example, the information may be stored in a look-up-table (e.g., a history based HMVP table).
      c) In one example, the information may be stored in a local buffer representing data within the current block/CU/PU/TU/VPDU/CTU/CTU row/tile/tile group/slice/subpicture/picture.
      d) In one example, the information may be stored in a temporal buffer representing data for a temporal reference unit.
   v. In one example, the information may be stored in M×N units, such as 4×4 units.
   vi. In one example, the information may be stored in a history table.
   vii. In one example, the information may be considered when comparing two CCP candidates.
      a. For example, two CCP candidates may be considered as different if the information of the two CCP candidates are different.
      b. Alternatively, the information may be ignored when comparing two CCP candidates.
   viii. In one example, the stored information may be used for future block's coding (e.g., intra prediction, CCP prediction, transform, deblocking, in-loop filtering, and etc.).
      a) In one example, the stored information may be inherited by a future block for its CCP parameters derivation/inheritance.
         1) For example, it may be used for a future block coded with non-local CCP mode.
         2) For example, it may be used for a future block coded with cross-component merge (CCMerge) mode.
b. In one example, for a non-local CCP mode (or CCP candidate mode, or cross-component merge (CCMerge) mode) coded block, whether the prediction of such block is processed by a certain filter may be inherited from a CCP candidate (e.g., stored CCP information from a neighbor block or a certain buffer/table, etc.).
   a. For example, the prediction filtering may be applied to such block, in case that the CCP candidate is coded with prediction filtering.
   b. Alternatively, whether the prediction of such block is processed by a certain filter may be signalled in the bitstream.
      i. For example, it may be determined at the encoder and signalled in the bitstream.
   c. Alternatively, the prediction block filtering may not be allowed for such block.
      i. For example, syntax elements related to prediction filtering may not be signalled for such block.
      ii. For example, the prediction filtering status may not be stored for a CCP coded block and may not be used for future CCP block's coding.
c. In one example, for a non-local CCP mode (or CCP candidate mode, or cross-component merge (CCMerge) mode) coded block, the CCP model parameters for different color components (e.g., Cb and Cr) may be different.
   a. For example, the threshold(s) for categorizing samples into different groups of a multi-model CCP mode may be different for Cb and Cr.
   b. For example, the CCP model type (e.g., CCLM, CCCM, CCCM w/o downsampling, GL-CCCM, CCCM-MDF, etc.) may be different for Cb and Cr.
   c. For example, the prediction filtering status may be different for Cb and Cr.
   d. For example, whether to use single model or multi-model may be different for Cb and Cr.
d. In one example, for a non-local CCP mode (or CCP candidate mode, or, cross-component merge (CCMerge) mode) coded block, the CCP information for different color components (e.g., Cb and Cr) may be derived from CCP candidates individually.
   a. For example, the threshold for categorizing samples into different groups of a multi-model CCP mode for each color component (e.g., Cb and Cr) may be derived independently.
      i. Alternatively, the threshold may be derived from either Cb or Cr component (e.g., although the thresholds of Cb and Cr may be different.).
   b. For example, the prediction filtering status for each color component (e.g., Cb and Cr) may be derived independently.
      i. Alternatively, the threshold may be derived from either Cb or Cr component (e.g., although the prediction filtering status of Cb and Cr may be different.).
   c. For example, the CCP model type for each color component (e.g., Cb and Cr) may be derived independently.
      i. Alternatively, the CCP model type may be derived from either Cb or Cr component (e.g., although the CCP model type of Cb and Cr may be different.).
   d. For example, the CCP model coefficients/parameters for each color component (e.g., Cb and Cr) may be derived independently.
      i. Alternatively, the CCP model coefficients/parameters may be derived from either Cb or Cr component (e.g., although the CCP model coefficients/parameters of Cb and Cr may be different.).
   e. For example, the CCP information for both Cb and Cr may be derived from one CCP candidate.
      i. Furthermore, alternatively, a candidate index may be signalled in the bitstream to specify the CCP information is derived from which CCP candidate.
      ii. Alternatively, the CCP information for Cb and Cr may be derived from different CCP candidates.
         1. Furthermore, alternatively, two candidate indexes (one for Cb, the other for Cr) may be signalled in the bitstream to specify the CCP information is derived from which CCP candidate.
e. In one example, for a non-local CCP mode (or CCP candidate mode, or cross-component merge (CCMerge) mode) coded block, whether the prediction of such block is processed by a certain filter may be signaled to the decoder.
f. In one example, a template-cost based methods may be applied to a non-local CCP mode (or CCP candidate mode, or, cross-component merge (CCMerge) mode) coded block.
   a. For example, whether to a template-cost based method to a non-local CCP mode coded block may be signaled to the decoder.
      i. For example, whether to a template-cost based method to a non-local CCP mode coded block may be derived at the decoder.
   b. For example, a template-cost based method may be used to determine the training/reference/neighboring region used to calculate the CCP model.
      i. For example, whether to use M1 or M2 rows/columns of training/reference/neighboring region may be determined by a template-cost based method.
   c. For example, a template-cost based method may be used to determine the threshold for categorizing samples into different groups of a multi-model CCP mode.
      i. For example, whether to use neighboring luma samples or collocated luma samples to compute the threshold may be determined by a template-cost based method.
   d. The disclosed methods in bullet 4.1 and sub-bullets may be applied to a non-local CCP mode (or, cross-component merge (CCMerge) mode) coded block.
   e. For example, a template-cost based method may be applied to Cb and Cr color components jointly.
      i. For example, Cb and Cr share one mode decision result from the template-cost based method.
   f. For example, a template-cost based method may be applied to Cb or Cr color components, individually.
      i. For example, Cb and Cr may have different mode decision results from the template-cost based methods.
   g. In one example, a template-cost based methods may be applied to a non-local CCP mode (or CCP candidate mode, or, cross-component merge (CCMerge) mode) coded block.
      i. For example, the CCP candidate list may be reordered.
      ii. For example, which CCP candidate is used may be determined based on template cost.
      iii. For example, more than one CCP candidate may be selected and fused together, and which CCP candidates are selected may be determined based on template cost.

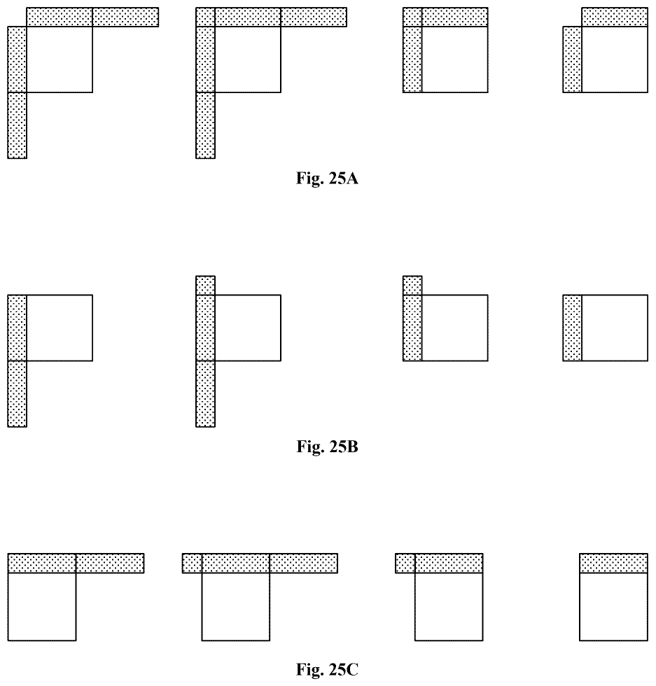

4.5 For example, the extended template mentioned in the disclosed methods may be defined based on whether the template contains left and above neighboring samples exceeding the vertical or horizontal range of current video unit (e.g., CU), as depicted in FIG. 25A.
a. Alternatively, furthermore, the template may contain top-left neighboring sample.
b. Alternatively, furthermore, the template may not contain top-left neighboring sample.

4.6 For example, the extended template mentioned in the disclosed methods may be defined based on whether the template contains left neighboring samples exceeding the vertical range of current video unit (e.g., CU)), as depicted in FIG. 25B.
a. Alternatively, furthermore, the template may contain top-left neighboring sample.
b. Alternatively, furthermore, the template may not contain top-left neighboring sample.

4.7 For example, the extended template mentioned in the disclosed methods may be defined based on whether the template contains above neighboring samples exceeding the horizontal range of current video unit (e.g., CU), as depicted in FIG. 25C. FIGS. 25A-25C illustrate possible template type used for CCP modes, wherein the hollow block indicates a video unit, and the shaded area indicates the template containing left and/or above neighboring samples.
a. Alternatively, furthermore, the template may contain top-left neighboring sample.
b. Alternatively, furthermore, the template may not contain top-left neighboring sample.

4.8 In one example, at least one kind of CCP mode may not use/allow extended template.
a. For example, extended template may not be applied to CCLM mode.
b. For example, extended template may not be applied to GLM mode.
c. For example, extended template may not be applied to GL-CCCM mode.
d. For example, extended template may not be applied to CCCM with downsampling mode.
e. For example, extended template may not be applied to CCCM without downsampling mode.
f. For example, extended template may not be applied to multiple downsampling filter based CCCM mode.

4.9 In one example, multiple downsampling filters may be used/allowed for a CCP mode.
a. For example, it may be applied to a CCLM block.
b. For example, whether to use the multiple downsampling filtering mode may be signalled based on a syntax element (e.g., a flag).
   a. Alternatively, it may be inferred/derived by decoding information/cost.
c. For example, at least one CCP model contains more than one pre-defined downsampling filter.

4.10 In one example, with a disclosed method, different mode decision results may be produced for Cb component or Cr component.
a. For example, Cb and Cr may have different template cost-based decisions.
   a. For example, the template cost for a first component (e.g., Cb) may be calculated firstly and a mode decision is made for the first component, then the template cost for a second component (e.g., Cr) may be calculated secondly and another mode decision is made for the second component.
   b. For example, for a video unit, Cb and Cr may use different intra chroma fusion mechanisms.
      i. For example, the nonLM prediction of Cb may be fused with a type of LM mode (e.g., MM-CCLM), while the nonLM prediction of Cr may be fused with another type of LM mode (e.g., MM-CCCM).
      ii. For example, different threshold values may be used for separating Cb and Cr samples for a multi-model intra chroma fusion.
      iii. For example, different training ranges may be used for modulating Cb and Cr CCP models for a single model intra chroma fusion.
   c. For example, for a video unit, Cb and Cr may use different thresholds values for a multi-model CCP mode.
      i. For example, different threshold values may be used for separating Cb and Cr samples for a multi-model CCP mode.
   d. For example, for a video unit, Cb and Cr may use different training samples for a CCP mode.
      i. For example, whether to use M (e.g., M=6) or N (e.g., N=2) rows/columns of training samples.
b. For example, a CCP parameter of Cb may be stored/inherited for a future block's Cb and Cr coding.
   a. Alternatively, a CCP parameter of Cr may be stored/inherited for a future block's Cb and Cr coding.
   b. Alternatively, a CCP parameter of Cb may be stored/inherited for a future block's Cb coding, while the CCP parameter of Cr may be stored/inherited for a future block's Cr coding.

4.11 In one example, with a disclosed method, a same mode decision result may be produced for Cb component or Cr component.

a. For example, one template cost-based decision result may be made for both Cb and Cr.
   a. For example, one template cost may be calculated by accumulating the costs for Cb and Cr, and then a mode decision is made based on the joint template cost.
   b. For example, for a video unit, which type of LM mode (e.g., MM-CCLM or MM-CCCM) is used to fuse Cb with a nonLM prediction and to fuse Cr with a nonLM prediction in an intra chroma fusion mode may be determined jointly.
      i. Furthermore, for example, which threshold value is used for separating Cb and Cr samples for a multi-model intra chroma fusion may be determined jointly.
      ii. Furthermore, for example, which training range is used for modulating Cb and Cr CCP models for a single model intra chroma fusion may be determined jointly.
   c. For example, for a video unit, which threshold value is used for separating Cb and Cr samples for a multi-model CCP mode may be determined jointly.
   d. For example, for a video unit, which training range is used for modulating Cb and Cr CCP models for a CCP mode may be determined jointly.
      i. For example, whether to use M (e.g., M=6) or N (e.g., N=2) rows/columns of training samples for both Cb and Cr.
b. For example, a video unit level CCP parameter may be stored/inherited for a future block's Cb and Cr coding.
   a. For example, either MM-CCLM or MM-CCCM model parameters may be stored for an intra chroma fusion block, and used for both Cb and Cr coding of a future CCP mode.
   b. For example, one threshold value may be stored for a multi-model CCP mode, and used for both Cb and Cr coding of a future CCP mode.

4.12 About the similarity check between two candidates and related issues (e.g., the 5th problem), the following methods are proposed:
a. For example, a mode information derived from a reference block may be checked during the similarity check.
   a. For example, to perform similarity check between a to-be-inserted motion candidate and an already-inserted motion candidate in the list, the intra or SCC mode information associated with the two motion candidates may be compared.
      i. For example, the intra or SCC mode information of a motion candidate may be derived from a reference block.
      ii. For example, the intra or SCC mode information of a motion candidate may be derived from a reference block of a reference block.
      iii. For example, the reference block may be from a reference picture.
      iv. For example, the reference block may be from the current picture.
      v. For example, if the intra or SCC mode associated with the two motion candidates are different, the to-be-inserted motion candidate may be treated as a different motion candidate and can be inserted to the list.
         1. Otherwise, for example, the to-be-inserted inter motion candidate may be treated as a same motion candidate and may NOT be inserted to the list.
   b. For example, the list may be a inter motion list, a inter/intra mode list, an IBC/RRIBC motion list, a HMVP table, a MPM list, etc.
   c. For example, the list may be used for AMVP prediction, or MERGE prediction, or intra prediction, IBC/RRIBC prediction, etc.

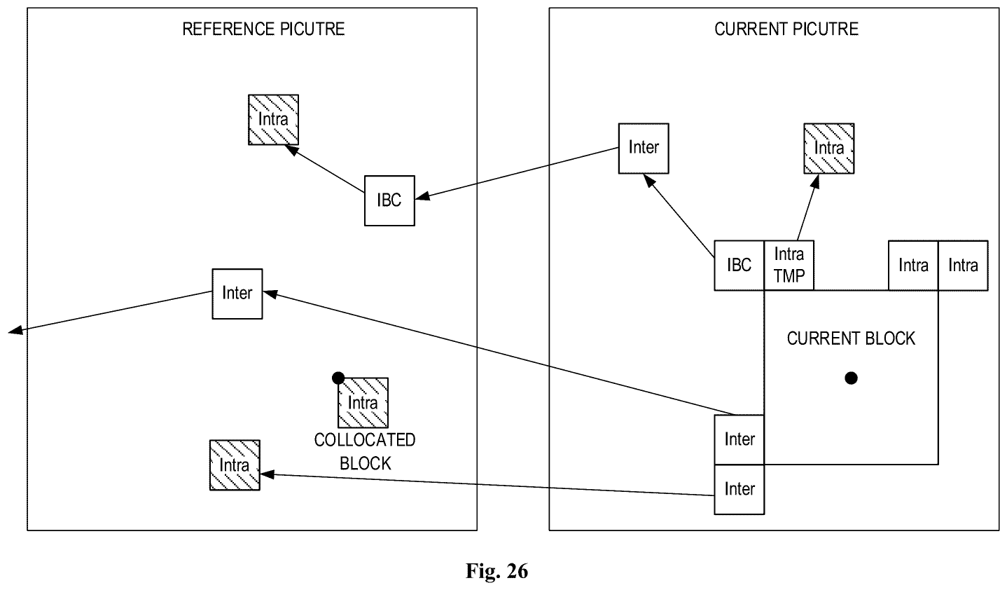

4.13 About the temporal candidates for intra prediction and related issues (e.g., the 6th problem), the following methods are proposed:
a. For example, an intra prediction method may be applied based on a temporal candidate.
   a. For example, the intra prediction method may be a cross-component merge (CCMerge) mode.
   b. For example, the intra prediction method may be a non-local CCP mode (e.g., history based, non-adjacent based CPP mode).
   c. For example, the intra prediction method may be a CCP mode.
   d. For example, the intra prediction method may be a TIMD mode.
   e. For example, the intra prediction method may be a GPM/SGPM mode.
   f. For example, the intra prediction method may be a TMRL/MRL mode.
   g. For example, the intra prediction method may be intra MPM/IPM list generation (e.g., for regular intra, SGPM, TMRL, TIMD, MRL, GPM inter-intra, etc.).
   h. For example, the intra prediction method may be an intraTMP mode.
   i. For example, the intra prediction method may be a DBV (e.g., direct block vector) mode.
   j. For example, the intra prediction method may be an IBC/RR-IBC mode.
b. For example, at least one of the following intra coded information may be derived based on a temporal candidate.
   a. Luma intra mode.
   b. Chroma intra mode.
   c. CCP parameters (e.g., CCP model, CCP type, luma offset, multi-model threshold, of CCLM/MMLM/CCCM/GL-CCCM/non-downsampled-CCCM/CCCM-MDF/GLM/intra chroma fusion, and etc.).
   d. GPM/SGPM partition mode index.
   e. a mapped intra mode based on GPM/SGPM partition index.
   f. block vector.
   g. motion vector.
c. For example, a temporal candidate may be derived based on a temporal reference video unit in a temporal reference picture.
   a. For example, the temporal reference video unit may be identified based on a motion vector of a (adjacent, non-adjacent, history-based) neighboring inter coded block of the current block, as illustrated in FIG. 26. FIG. 26 illustrates an example of temporal candidates for intra prediction, and shaded blocks may be used as temporal candidates.
   b. For example, the temporal reference video unit may be a collocated block in a reference picture, which has same position as the center/bottom-right position of the current video unit relative to the top-left position the current picture, as illustrated in FIG. 26.
   c. For example, the temporal reference video unit may be identified based on a motion shift.
      i. For example, the motion shift may be derived based on template cost.
   d. For example, the temporal reference video unit may be intra/CCP coded.
      i. Alternatively, the temporal reference video unit may be IBC coded, and the reference block of such IBC coded reference block is intra/CCP coded.
      ii. Alternatively, the temporal reference video unit may be intraTMP coded, and the reference block of such intraTMP coded block is intra/CCP coded.
      iii. Alternatively, the temporal reference video unit may be inter coded, and a reference block of such inter coded block is intra/CCP coded.
d. For example, a temporal candidate may be derived based on already coded block in the current picture.
   a. For example, the temporal information may be derived by an inter coded block identified by a block vector relative to the current block, as illustrated in FIG. 26.
      i. For example, the inter coded block in the current picture may be identified based on a block vector from an IBC coded neighbor block.
      ii. For example, the inter coded block in the current picture may be identified based on a block vector from an intraTMP coded neighbor block.
      iii. For example, a temporal reference video unit may be further identified based on the derived inter coded block in the current picture.
   b. For example, the temporal reference video unit may be intra/CCP coded.
      i. Alternatively, an intra coding information may be derived based on the temporal reference video unit.
e. For example, a temporal candidate may be derived based on a historical propagated intra/CCP information.
   a. For example, the historical propagated intra/CCP information may be derived associated with a neighbor block.
f. For example, a derived intra coded information of a current video unit may be stored in a buffer and used as a temporal candidate for future block's coding.
   a. For example, the current video unit may be inter coded.
   b. For example, the current video unit may be intra coded.
   c. For example, the current video unit may be IBC coded.
   d. For example, the current video unit may be intraTMP coded.
   e. For example, the derived intra coded information of the current video unit may be stored associated with the motion/mode information of the current video unit.
   f. For example, the stored intra coded information may be luma/chroma intra mode, CCP parameters, etc.
   g. For example, it may be a historical propagated intra/CCP information.
g. For example, more than one temporal candidate may be used for intra/CCP prediction.
   a. For example, multiple temporal candidates may be accessed in a reference picture following a pre-defined checking order.
      i. For example, the checking order of temporal candidates may be based on the prediction type of neighboring blocks of the current video unit (e.g., whether a neighbor is intra coded or not).
      ii. For example, the positions of temporal candidates may be adjacent or non-adjacent to a certain temporal video unit.
         1. For example, the certain temporal video unit may be identified by a default motion vector, or a motion vector of a neighbor block, or a derived motion vector.
         2. For example, the checking positions may be dependent on the block dimensions (width and/or height) of the current video unit.
         3. For example, the checking positions may be on the top and/or left region of the certain temporal video unit.
         4. For example, the checking positions may be on the bottom and/or right region of the certain temporal video unit.
   b. For example, the temporal candidates may be reordered.
      i. For example, the reordering may be based on a template cost calculated between prediction values and reconstruction values of samples in the template.
   c. For example, the checking order of temporal candidates for an inter prediction, and/or an intra prediction, and/or an IBC prediction may be aligned.
h. For example, a similarity check may be applied to determine whether a temporal candidate may be used for an intra/CCP mode.
   a. For example, whether the temporal candidate is inserted to a candidate list may be determined based on a similarity check (or pruning process).
      i. For example, a temporal candidate may be inserted to a candidate list after the spatial adjacent candidates.

4.14 About the chroma fusion for inter and/or intra coding and related issues, the following methods are proposed:
a. For example, a list of chroma fusion candidates may be generated based on decoding information.
   a. For example, a chroma fusion candidate may be based at least one of the following modes:
      i. Intra/inter CCCM,
      ii. CCCM with MDF,
      iii. GL-CCCM,
      iv. CCLM,
      v. GLM,
      vi. GL-CCCM,
      vii. LBCCP,
      viii. Single model,
      ix. Multi-model,
      x. DIMD,
      xi. TIMD,
      xii. DM,
      xiii. linear model based,
      xiv. non-linear model based,
      xv. convolutional model based.
   b. For example, what type of chroma fusion candidates are included in the list may be determined based on a pre-defined rule.
b. For example, a chroma fusion candidate may be on-the-fly calculated from a reference/training region.
   a. For example, a chroma fusion filter/model may be derived based on minimizing the difference between luma sample values and chroma sample values of a reference/training region/block.
      i. For example, a chroma fusion model may be applied to the luma reconstruction samples of the reference/training region/block and get the resultant model-estimated samples, then a minimization process is conducted based on the resultant model-estimated samples and the chroma reconstruction sample values of the reference/training region/block.
      ii. For example, furthermore, the reference/training region/block may be adjacent/non-adjacent/temporally/collocated to the current block.
      iii. For example, furthermore, the reference/training region/block may be derived based on a block vector.
      iv. For example, furthermore, the reference/training region/block may be derived based on a motion vector.
   b. For example, a chroma fusion filter/model may be derived based on minimizing the difference between reference template and current template.
      i. For example, the reference template may be adjacent/non-adjacent to a reference block.
      ii. For example, the current template may be adjacent/non-adjacent to the current block.
      iii. For example, a model may be applied to the reference template samples and get the resultant model-estimated samples, then a minimization process is conducted based on the resultant model-estimated samples and the reconstruction current template sample values.
   c. For example, the above filter/model may be calculated based on a training set constructing from a group of samples from {current block, BV/MV guided reference block, template, non-adjacent block, adjacent block, temporal collocated block, temporal block adjacent/non-adjacent to the collocated block, etc.}.
      i. For example, more than one type of samples may be used.
      ii. For example, for a specific model's calculation, the training samples used for the model coefficient calculation may be derived from previous coded blocks which are coded by such specific model.
         1. For example, the specific model may be based on CCLM, intra/inter/BVG CCCM, CCCLM w/MDF, GL-CCCM, GLM, etc.
c. For example, a chroma fusion candidate may be inherited from a previous coded block.
d. For example, a LBCCP flag may be added to a chroma fusion candidate.
   a. For example, the LBCCP flag may be inherited from a previous block.
e. For example, whether to add a LBCCP coded chroma fusion candidate may be determined/derived/calculated based on template cost (e.g., by comparing template costs between with and without a low-pass filter).
   a. For example, for a non-LBCCP mutli-model CCP candidate in the list, a LBCCP flag may be added to such candidate.
      i. For example, the newly generated LBCCP based mutli-model CCP candidate may be inserted to replace the original non-LBCCP mutli-model CCP candidate.
      ii. For example, alternatively, the newly generated LBCCP based mutli-model CCP candidate may be inserted as an additional new candidate.
   b. For example, for a LBCCP mutli-model CCP candidate in the list, the LBCCP flag may be removed from such candidate.
      i. For example, the newly generated non-LBCCP based mutli-model CCP candidate may be inserted to replace the original LBCCP mutli-model CCP candidate.
      ii. For example, alternatively, the newly generated non-LBCCP based mutli-model CCP candidate may be inserted as an additional new candidate.
f. For example, the prediction of a chroma fusion candidate may be fused with a second prediction, wherein the second prediction may be based on at least one of the following modes:
   a. Regular Intra chroma prediction,
   b. Inter chroma prediction,
   c. Intra angular chroma prediction,
   d. Intra non-angular chroma prediction,
   e. Multi-model CCP prediction,
   f. intraCCP prediction,
   g. interCCP prediction,
   h. intraCCP merge prediction,
   i. interCCP merge prediction,
   j. TIMD,
   k. DIMD,
   l. DM,
   m. IBC chroma prediction,
   n. intraTMP chroma prediction,
   o. DBV prediction.
g. For example, which chroma fusion candidate is chosen for fusion may be determined based on de decoder derived cost (e.g., template cost).
   i. For example, the chroma fusion candidates in the list may be sorted/reordered.
      1. For example, the sorting may be processed based on template cost.
      2. For example, a candidate index may be signalled to indicate which candidate model is finally chosen for the current block's coding.
      3. Alternatively, the candidate model with lowest cost after sorting may be used by default for the current block's coding (e.g., without an index signalling).
   ii. For example, for intraCCP/interCCP merge mode, the merge prediction is fused with a chroma fusion candidate, wherein the chroma fusion candidate may be determined based on a template cost.
h. For example, alternatively, which chroma fusion candidate in the list is chosen for fusion may be determined at the encoder side and signalled in the bitstream.
   i. For example, for an intraCCP/interCCP mode (e.g., implicit mode), the intraCCP/interCCP prediction is fused with a chroma fusion candidate, wherein the chroma fusion candidate may be signalled in the bitstream.

4.15 About the LBCCP filter and related issues, the following methods are proposed:
a. For example, whether to apply an LBCCP filter to a CCP mode/candidate may be determined based on template cost.
   a. For example, template costs may be calculated for a CCP mode/candidate by applying and not applying a low-pass filter to a template.
      i. For example, a LBCCP filter may be added to the CCP candidate if applying the low pass filter results in lower template cost.
      ii. For example, alternatively, a LBCCP filter may be removed from the CCP candidate if applying the low pass filter results in higher template cost.
      iii. For example, the low pass filter may be 3-tap based.
   b. For example, for a non-LBCCP mutli-model CCP candidate in the list, a LBCCP flag may be added to such candidate.
      i. For example, the newly generated LBCCP based mutli-model CCP candidate may be inserted to replace the original non-LBCCP mutli-model CCP candidate.
      ii. For example, alternatively, the newly generated LBCCP based mutli-model CCP candidate may be inserted as an additional new candidate.
   c. For example, for a LBCCP mutli-model CCP candidate in the list, its LBCCP flag may be removed from such candidate.
      i. For example, the newly generated non-LBCCP based mutli-model CCP candidate may be inserted to replace the original LBCCP mutli-model CCP candidate.
      ii. For example, alternatively, the newly generated non-LBCCP based mutli-model CCP candidate may be inserted as an additional new candidate.
b. For example, whether to apply an LBCCP filter to a CCP candidate may be inherited from a previous block.
   a. For example, if the selected CCP candidate for the current block is LBCCP coded, the LBCCP filter may be applied to the current block.
c. For example, an interCCP/intraCCP mode may be applied based on a LBCCP candidate.
   a. For example, a decoder derived intraCCP/interCCP candidate list may be generated based on a LBCCP based model.
   b. For example, the interCCP/intraCCP mode may be a merge mode.
   c. For example, the interCCP/intraCCP mode may NOT be a merge mode.

4.16 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

4.17 Whether to and/or how to apply the disclosed methods above may be signalled at PB/TB/CB/PU/TU/CU/VPDU/CTU/CTU row/slice/tile/sub-picture/other kinds of region contain more than one sample or pixel.

4.18 Whether to and/or how to apply the disclosed methods above may be dependent on coded information, such as block size, colour format, single/dual tree partitioning, colour component, slice/picture type.

More details of the embodiments of the present disclosure will be described below which are related to coding scheme of different color components. The embodiments of the present disclosure should be considered as examples to explain the general concepts and should not be interpreted in a narrow way. Furthermore, these embodiments can be applied individually or combined in any manner.

As used herein, the term “video unit” may represent a block, a subblock, a coding tree block (CTB), a coding tree unit (CTU), a coding block (CB), a coding unit (CU), a prediction unit (PU), a transform unit (TU), a prediction block (PB), a transform block (TB), a tile, a slice, a subpicture, a video processing unit comprising multiple samples/pixels, and/or the like. A video unit may be rectangular or non-rectangular.

Moreover, a chroma component may comprise a Cb component and/or a Cr component. For example, the Cb component may represent a blue-difference chroma component and the Cr component may represent a red-difference chroma component. In another example, Cb and Cr components may be substituted by U and V components. It should be understood that the Cb component and/or the Cr component may represent any other suitable color component. In addition, although the solutions according to some embodiments of the present disclosure will be described with regard to a chroma component, the concept of these solutions may also be applied to any other suitable color component, such as a luma component, a red (R) component, a green (G) component, a blue (B) component, or the like. The scope of the present disclosure is not limited in this respect.

As used herein, the term “reference area” may refer to an area used to determine a CCP model. For example, parameters of the CCP model may be determined based on reconstructed luma and chroma samples in the reference area. In such a case, these samples used to determine the CCP model may also be referred to as “training samples” or “reference samples”. Moreover, the terms “reference area”, “reference region”, “training area”, and “training region” may be used interchangeably.

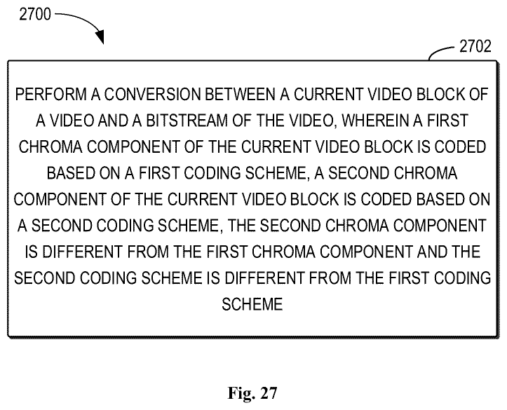

FIG. 27 illustrates a flowchart of a method 2700 for video processing in accordance with some embodiments of the present disclosure. As shown in FIG. 27. at 2702, a conversion is performed between a current video block of a video and a bitstream of the video. A first chroma component of the current video block is coded based on a first coding scheme, while a second chroma component of the current video block is coded based on a second coding scheme. The second chroma component is different from the first chroma component, and the second coding scheme is different from the first coding scheme. In some embodiments, the first chroma component may be a Cb component and the second chroma component may be a Cr component. Alternatively, the first chroma component may be a Cr component and the second chroma component may be a Cb component. In some embodiments, the first coding scheme and the second coding scheme are based on cross-component prediction (CCP).

By way of example rather than limitation, different mode decision results may be produced for Cb component and Cr component. A mode decision result for a chroma component may indicate the coding mode used for coding the chroma component. In addition, the mode decision result may further indicate parameters and/or configuration of the coding mode, for example, model parameters for the CCP mode, a threshold for multi-model based CCP model, and/or the like.

In view of the above, the different chroma components of a same block are coded with different coding schemes. Compared with the conventional solution where the same coding scheme is used for coding different chroma components, the proposed method can advantageously support independent coding of different chroma components, and thus the coding quality can be improved.

In some embodiments, the first coding scheme and the second coding scheme are determined based on template-cost-based scheme. For example, a template cost for the first chroma component and a template cost for the second chroma component may be determined separately. For example, the template cost for a first chroma component (e.g., Cb) may be calculated firstly and a mode decision is made for the first chroma component, then the template cost for a second chroma component (e.g., Cr) may be calculated and another mode decision is made for the second chroma component.

In some embodiments, the first coding scheme comprises a first intra chroma fusion scheme, and the second coding scheme comprises a second intra chroma fusion scheme different from the first intra chroma fusion scheme. In an intra chroma fusion scheme, more than one candidate prediction for a chroma component is fused to obtain a final prediction for the chroma component.

In some embodiments, a prediction for the first chroma component determined with a non-linear model (non-LM) mode is fused with a further prediction for the first chroma component determined with a first type of linear model (LM). Moreover, a prediction for the second chroma component determined with a non-LM mode is fused with a further prediction for the second chroma component determined with a second type of LM different from the first type of LM. By way of example rather than limitation, the first type of LM comprises a multi-model cross-component linear model (MM-CCLM) mode, and the second type of LM comprises a multi-model convolutional cross-component model (MM-CCCM) mode.

In some embodiments, both the first intra chroma fusion scheme and the second intra chroma fusion scheme are multi-model based. In this case, a threshold used for classifying samples of the first chroma component for the first intra chroma fusion scheme may be different from a threshold used for classifying samples of the second chroma component for the second intra chroma fusion scheme. For example, samples are classified into different categories for determining more than one CCP model.

In some embodiments, both the first intra chroma fusion scheme and the second intra chroma fusion scheme are single-model based, In this case, a range of training samples used for determining a CCP model of the first chroma component for the first intra chroma fusion scheme is different from a range of training samples used for determining a CCP model of the second chroma component for the second intra chroma fusion scheme.

In some embodiments, the first coding scheme comprises a first multi-model CCP scheme, while the second coding scheme comprises a second multi-model CCP scheme different from the first multi-model CCP scheme. For example, a threshold used for classifying samples of the first chroma component for the first multi-model CCP scheme may be different from a threshold used for classifying samples of the second chroma component for the second multi-model CCP scheme.

In some embodiments, training samples used for determining a CCP model of the first chroma component for the first intra chroma fusion scheme is different from training samples used for determining a CCP model of the second chroma component for the second intra chroma fusion scheme. By way of example, a first range of training samples used for determining a CCP model of the first chroma component for the first intra chroma fusion scheme is different from a second range of training samples used for determining a CCP model of the second chroma component for the second intra chroma fusion scheme. For example, the first range comprises M rows of training samples and/or N rows of training samples, while the second range comprises R rows of training samples and/or Q rows of training samples. Each of M, N, R and Q is a non-negative integer, such as 1, 2, 4, 5, or the like.

In some embodiments, a CCP parameter for coding the first chroma component is stored for coding the first chroma component and the second chroma component of a further video block of the video. The current video block is coded before the further video block. In other words, the further video block is to be coded after the current video block. Additionally or alternatively, the CCP parameter for coding the first chroma component is inherited for coding the first chroma component and the second chroma component of the further video block.

In some alternative embodiments, a CCP parameter for coding the second chroma component is stored for coding the first chroma component and the second chroma component of the further video block. Additionally or alternatively, the CCP parameter for coding the second chroma component is inherited for coding the first chroma component and the second chroma component of the further video block.

In some embodiments, a CCP parameter for coding the first chroma component is stored for coding the first chroma component of the further video block, and a CCP parameter for coding the second chroma component is stored for coding the second chroma component of the further video block. Additionally or alternatively, the CCP parameter for coding the first chroma component is inherited for coding the first chroma component of the further video block, and the CCP parameter for coding the second chroma component is inherited for coding the second chroma component of the further video block.

In some embodiments, whether to and/or how to apply the method is indicated at one of the following: a sequence level, a group of pictures level, a picture level, a slice level, or a tile group level.

In some embodiments, whether to and/or how to apply the method is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method is indicated at a region containing more than one sample or pixel. By way of example rather than limitation, the region comprises at least one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

In some embodiments, whether to and/or how to apply the method is dependent on coded information. For example, the coded information comprises at least one of the following: a block size, a color format, a single dual tree partitioning, a dual tree partitioning, a color component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, perform a conversion between a current video block of the video and the bitstream. A first chroma component of the current video block is coded based on a first coding scheme, while a second chroma component of the current video block is coded based on a second coding scheme. The second chroma component is different from the first chroma component, and the second coding scheme is different from the first coding scheme.

According to still further embodiments of the present disclosure, a method for storing bitstream of a video is provided. In the method, perform a conversion between a current video block of the video and the bitstream. A first chroma component of the current video block is coded based on a first coding scheme, while a second chroma component of the current video block is coded based on a second coding scheme. The second chroma component is different from the first chroma component, and the second coding scheme is different from the first coding scheme. Moreover, the bitstream is stored in a non-transitory computer-readable recording medium.

Implementations of the present disclosure can be described in view of the following clauses, the features of which can be combined in any reasonable manner.

Clause 1. A method for video processing, comprising: performing a conversion between a current video block of a video and a bitstream of the video, wherein a first chroma component of the current video block is coded based on a first coding scheme, a second chroma component of the current video block is coded based on a second coding scheme, the second chroma component is different from the first chroma component and the second coding scheme is different from the first coding scheme.

Clause 2. The method of clause 1, wherein the first chroma component is a Cb component and the second chroma component is a Cr component.

Clause 3. The method of any of clauses 1-2, wherein the first coding scheme and the second coding scheme are based on cross-component prediction (CCP).

Clause 4. The method of any of clauses 1-3, wherein the first coding scheme and the second coding scheme are determined based on template-cost-based scheme.

Clause 5. The method of clause 4, wherein a template cost for the first chroma component and a template cost for the second chroma component are determined separately.

Clause 6. The method of any of clauses 1-5, wherein the first coding scheme comprises a first intra chroma fusion scheme, and the second coding scheme comprises a second intra chroma fusion scheme different from the first intra chroma fusion scheme.

Clause 7. The method of clause 6, wherein a prediction for the first chroma component determined with a non-linear model (non-LM) mode is fused with a further prediction for the first chroma component determined with a first type of linear model (LM), and a prediction for the second chroma component determined with a non-LM mode is fused with a further prediction for the second chroma component determined with a second type of LM different from the first type of LM.

Clause 8. The method of clause 7, wherein the first type of LM comprises a multi-model cross-component linear model (MM-CCLM) mode, and the second type of LM comprises a multi-model convolutional cross-component model (MM-CCCM) mode.

Clause 9. The method of any of clauses 6-8, wherein both the first intra chroma fusion scheme and the second intra chroma fusion scheme are multi-model based, and a threshold used for classifying samples of the first chroma component for the first intra chroma fusion scheme is different from a threshold used for classifying samples of the second chroma component for the second intra chroma fusion scheme.

Clause 10. The method of any of clauses 6-8, wherein both the first intra chroma fusion scheme and the second intra chroma fusion scheme are single-model based, and a range of training samples used for determining a CCP model of the first chroma component for the first intra chroma fusion scheme is different from a range of training samples used for determining a CCP model of the second chroma component for the second intra chroma fusion scheme.

Clause 11. The method of any of clauses 1-5, wherein the first coding scheme comprises a first multi-model CCP scheme, and the second coding scheme comprises a second multi-model CCP scheme different from the first multi-model CCP scheme.

Clause 12. The method of clause 11, wherein a threshold used for classifying samples of the first chroma component for the first multi-model CCP scheme is different from a threshold used for classifying samples of the second chroma component for the second multi-model CCP scheme.

Clause 13. The method of any of clauses 1-5, wherein training samples used for determining a CCP model of the first chroma component for the first intra chroma fusion scheme is different from training samples used for determining a CCP model of the second chroma component for the second intra chroma fusion scheme.

Clause 14. The method of any of clauses 1-5, wherein a first range of training samples used for determining a CCP model of the first chroma component for the first intra chroma fusion scheme is different from a second range of training samples used for determining a CCP model of the second chroma component for the second intra chroma fusion scheme.

Clause 15. The method of clause 14, wherein the first range comprises at least one of M rows of training samples or N rows of training samples, the second range comprises at least one of R rows of training samples or Q rows of training samples, and each of M, N, R and Q is a non-negative integer.

Clause 16. The method of any of clauses 3-15, wherein a CCP parameter for coding the first chroma component is stored for coding the first chroma component and the second chroma component of a further video block of the video, the current video block being coded before the further video block, or the CCP parameter for coding the first chroma component is inherited for coding the first chroma component and the second chroma component of the further video block.

Clause 17. The method of any of clauses 3-15, wherein a CCP parameter for coding the second chroma component is stored for coding the first chroma component and the second chroma component of a further video block of the video, the current video block being coded before the further video block, or the CCP parameter for coding the second chroma component is inherited for coding the first chroma component and the second chroma component of the further video block.

Clause 18. The method of any of clauses 3-15, wherein a CCP parameter for coding the first chroma component is stored for coding the first chroma component of a further video block of the video, and a CCP parameter for coding the second chroma component is stored for coding the second chroma component of the further video block, the current video block being coded before the further video block, or the CCP parameter for coding the first chroma component is inherited for coding the first chroma component of the further video block, and the CCP parameter for coding the second chroma component is inherited for coding the second chroma component of the further video block.

Clause 19. The method of any of clauses 1-18, wherein whether to and/or how to apply the method is indicated at one of the following: a sequence level, a group of pictures level, a picture level, a slice level, or a tile group level.

Clause 20. The method of any of clauses 1-18, wherein whether to and/or how to apply the method is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 21. The method of any of clauses 1-18, wherein whether to and/or how to apply the method is indicated at a region containing more than one sample or pixel.

Clause 22. The method of clause 21, wherein the region comprises at least one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 23. The method of any of clauses 1-22, wherein whether to and/or how to apply the method is dependent on coded information.

Clause 24. The method of clause 23, wherein the coded information comprises at least one of the following: a block size, a color format, a single dual tree partitioning, a dual tree partitioning, a color component, a slice type, or a picture type.

Clause 25. The method of any of clauses 1-24, wherein the conversion includes encoding the current video block into the bitstream.

Clause 26. The method of any of clauses 1-24, wherein the conversion includes decoding the current video block from the bitstream.

Clause 27. An apparatus for video processing comprising a processor and a non-transitory memory with instructions thereon, wherein the instructions upon execution by the processor, cause the processor to perform a method in accordance with any of clauses 1-26.

Clause 28. A non-transitory computer-readable storage medium storing instructions that cause a processor to perform a method in accordance with any of clauses 1-26.

Clause 29. A non-transitory computer-readable recording medium storing a bitstream of a video which is generated by a method performed by an apparatus for video processing, wherein the method comprises: perform a conversion between a current video block of the video and the bitstream, wherein a first chroma component of the current video block is coded based on a first coding scheme, a second chroma component of the current video block is coded based on a second coding scheme, the second chroma component is different from the first chroma component and the second coding scheme is different from the first coding scheme.

Clause 30. A method for storing a bitstream of a video, comprising: perform a conversion between a current video block of the video and the bitstream, wherein a first chroma component of the current video block is coded based on a first coding scheme, a second chroma component of the current video block is coded based on a second coding scheme, the second chroma component is different from the first chroma component and the second coding scheme is different from the first coding scheme; and storing the bitstream in a non-transitory computer-readable recording medium.

### Example Device

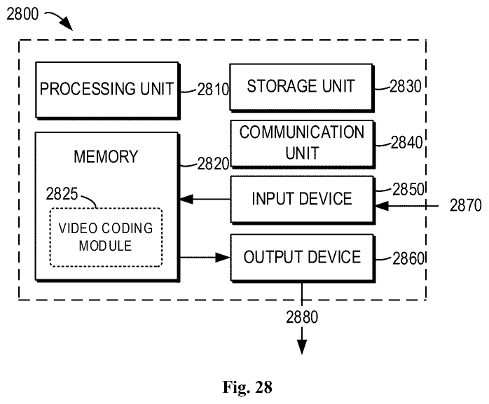

FIG. 28 illustrates a block diagram of a computing device 2800 in which various embodiments of the present disclosure can be implemented. The computing device 2800 may be implemented as or included in the source device 110 (or the video encoder 114 or 200) or the destination device 120 (or the video decoder 124 or 300).

It would be appreciated that the computing device 2800 shown in FIG. 28 is merely for purpose of illustration, without suggesting any limitation to the functions and scopes of the embodiments of the present disclosure in any manner.

As shown in FIG. 28, the computing device 2800 includes a general-purpose computing device 2800. The computing device 2800 may at least comprise one or more processors or processing units 2810, a memory 2820, a storage unit 2830, one or more communication units 2840, one or more input devices 2850, and one or more output devices 2860.

In some embodiments, the computing device 2800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2800 can support any type of interface to a user (such as “wearable” circuitry and the like).

The processing unit 2810 may be a physical or virtual processor and can implement various processes based on programs stored in the memory 2820. In a multi-processor system, multiple processing units execute computer executable instructions in parallel so as to improve the parallel processing capability of the computing device 2800. The processing unit 2810 may also be referred to as a central processing unit (CPU), a microprocessor, a controller or a microcontroller.

The computing device 2800 typically includes various computer storage medium. Such medium can be any medium accessible by the computing device 2800, including, but not limited to, volatile and non-volatile medium, or detachable and non-detachable medium. The memory 2820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2830 may be any detachable or non-detachable medium and may include a machine-readable medium such as a memory, flash memory drive, magnetic disk or another other media, which can be used for storing information and/or data and can be accessed in the computing device 2800.

The computing device 2800 may further include additional detachable/non-detachable, volatile/non-volatile memory medium. Although not shown in FIG. 28, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2840 communicates with a further computing device via the communication medium. In addition, the functions of the components in the computing device 2800 can be implemented by a single computing cluster or multiple computing machines that can communicate via communication connections. Therefore, the computing device 2800 can operate in a networked environment using a logical connection with one or more other servers, networked personal computers (PCs) or further general network nodes.

The input device 2850 may be one or more of a variety of input devices, such as a mouse, keyboard, tracking ball, voice-input device, and the like. The output device 2860 may be one or more of a variety of output devices, such as a display, loudspeaker, printer, and the like. By means of the communication unit 2840, the computing device 2800 can further communicate with one or more external devices (not shown) such as the storage devices and display device, with one or more devices enabling the user to interact with the computing device 2800, or any devices (such as a network card, a modem and the like) enabling the computing device 2800 to communicate with one or more other computing devices, if required. Such communication can be performed via input/output (I/O) interfaces (not shown).

In some embodiments, instead of being integrated in a single device, some or all components of the computing device 2800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2800 may be used to implement video encoding/decoding in embodiments of the present disclosure. The memory 2820 may include one or more video coding modules 2825 having one or more program instructions. These modules are accessible and executable by the processing unit 2810 to perform the functionalities of the various embodiments described herein.

In the example embodiments of performing video encoding, the input device 2850 may receive video data as an input 2870 to be encoded. The video data may be processed, for example, by the video coding module 2825, to generate an encoded bitstream. The encoded bitstream may be provided via the output device 2860 as an output 2880.

In the example embodiments of performing video decoding, the input device 2850 may receive an encoded bitstream as the input 2870. The encoded bitstream may be processed, for example, by the video coding module 2825, to generate decoded video data. The decoded video data may be provided via the output device 2860 as the output 2880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a current video block of a video and a bitstream of the video, wherein a first chroma component of the current video block is coded based on a first coding scheme, a second chroma component of the current video block is coded based on a second coding scheme, the second chroma component is different from the first chroma component and the second coding scheme is different from the first coding scheme.

2. The method of claim 1, wherein the first chroma component is a Cb component and the second chroma component is a Cr component.

3. The method of claim 1, wherein the first coding scheme and the second coding scheme are based on cross-component prediction (CCP).

4. The method of claim 1, wherein the first coding scheme and the second coding scheme are determined based on template-cost-based scheme.

5. The method of claim 4, wherein a template cost for the first chroma component and a template cost for the second chroma component are determined separately.

6. The method of claim 1, wherein the first coding scheme comprises a first intra chroma fusion scheme, and the second coding scheme comprises a second intra chroma fusion scheme different from the first intra chroma fusion scheme.

7. The method of claim 6, wherein a prediction for the first chroma component determined with a non-linear model (non-LM) mode is fused with a further prediction for the first chroma component determined with a first type of linear model (LM), and
a prediction for the second chroma component determined with a non-LM mode is fused with a further prediction for the second chroma component determined with a second type of LM different from the first type of LM.

8. The method of claim 7, wherein the first type of LM comprises a multi-model cross-component linear model (MM-CCLM) mode, and the second type of LM comprises a multi-model convolutional cross-component model (MM-CCCM) mode.

9. The method of claim 6, wherein both the first intra chroma fusion scheme and the second intra chroma fusion scheme are multi-model based, and a threshold used for classifying samples of the first chroma component for the first intra chroma fusion scheme is different from a threshold used for classifying samples of the second chroma component for the second intra chroma fusion scheme, or
wherein both the first intra chroma fusion scheme and the second intra chroma fusion scheme are single-model based, and a range of training samples used for determining a CCP model of the first chroma component for the first intra chroma fusion scheme is different from a range of training samples used for determining a CCP model of the second chroma component for the second intra chroma fusion scheme.

10. The method of claim 1, wherein the first coding scheme comprises a first multi-model CCP scheme, and the second coding scheme comprises a second multi-model CCP scheme different from the first multi-model CCP scheme.

11. The method of claim 10, wherein a threshold used for classifying samples of the first chroma component for the first multi-model CCP scheme is different from a threshold used for classifying samples of the second chroma component for the second multi-model CCP scheme.

12. The method of claim 1, wherein training samples used for determining a CCP model of the first chroma component for the first intra chroma fusion scheme is different from training samples used for determining a CCP model of the second chroma component for the second intra chroma fusion scheme, or
wherein a first range of training samples used for determining a CCP model of the first chroma component for the first intra chroma fusion scheme is different from a second range of training samples used for determining a CCP model of the second chroma component for the second intra chroma fusion scheme.

13. The method of claim 12, wherein the first range comprises at least one of M rows of training samples or N rows of training samples, the second range comprises at least one of R rows of training samples or Q rows of training samples, and each of M, N, R and Q is a non-negative integer.

14. The method of claim 3, wherein a CCP parameter for coding the first chroma component is stored for coding the first chroma component and the second chroma component of a further video block of the video, the current video block being coded before the further video block, or the CCP parameter for coding the first chroma component is inherited for coding the first chroma component and the second chroma component of the further video block, or
wherein a CCP parameter for coding the second chroma component is stored for coding the first chroma component and the second chroma component of a further video block of the video, the current video block being coded before the further video block, or the CCP parameter for coding the second chroma component is inherited for coding the first chroma component and the second chroma component of the further video block, or
wherein a CCP parameter for coding the first chroma component is stored for coding the first chroma component of a further video block of the video, and a CCP parameter for coding the second chroma component is stored for coding the second chroma component of the further video block, the current video block being coded before the further video block, or the CCP parameter for coding the first chroma component is inherited for coding the first chroma component of the further video block, and the CCP parameter for coding the second chroma component is inherited for coding the second chroma component of the further video block.

15. The method of claim 1, wherein whether to and/or how to apply the method is indicated at one of the following: a sequence level, a group of pictures level, a picture level, a slice level, or a tile group level, or
wherein whether to and/or how to apply the method is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header, or
wherein whether to and/or how to apply the method is indicated at a region containing more than one sample or pixel, or
wherein whether to and/or how to apply the method is dependent on coded information.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
performing a conversion between a current video block of a video and a bitstream of the video, wherein a first chroma component of the current video block is coded based on a first coding scheme, a second chroma component of the current video block is coded based on a second coding scheme, the second chroma component is different from the first chroma component and the second coding scheme is different from the first coding scheme.

19. A non-transitory computer-readable storage medium storing instructions that cause a processor to perform acts comprising:
performing a conversion between a current video block of a video and a bitstream of the video, wherein a first chroma component of the current video block is coded based on a first coding scheme, a second chroma component of the current video block is coded based on a second coding scheme, the second chroma component is different from the first chroma component and the second coding scheme is different from the first coding scheme.

20. A non-transitory computer-readable recording medium storing a bitstream of a video which is generated by a method performed by an apparatus for video processing, wherein the method comprises:
perform a conversion between a current video block of the video and the bitstream, wherein a first chroma component of the current video block is coded based on a first coding scheme, a second chroma component of the current video block is coded based on a second coding scheme, the second chroma component is different from the first chroma component and the second coding scheme is different from the first coding scheme.
